(19) United States
(12) Patent Application Publication
(10) Pub. No.: US 2016/0308775 A1
(43) Pub. Date: Oct. 20, 2016

(54) BASE STATION AND COMMUNICATION CONTROL METHOD

(71) Applicant: FUJITSU LIMITED, Kawasaki-shi (JP)

(72) Inventor: Yuji KOJIMA, Kawasaki (JP)

(21) Appl. No.: 15/092,194

(22) Filed: Apr. 6, 2016

(30) Foreign Application Priority Data
Apr. 20, 2015 (JP) 2015-086289

(51) Int. Cl. H04L 12/807; H04L 1/18; H04L 12/801

(52) U.S. Cl. CPC H04L 47/27; H04L 47/14; H04L 47/193; H04L 1/189

(57) ABSTRACT

A base station including: a memory configured to store a transmission buffer storing each packet to be transmitted to a terminal via a wireless channel, and a processor configured to: control volume of packets flowing in the transmission buffer based on a smaller value of a congestion window value and a receive window value, the congestion window value indicating a number of packets that the base station is allowed to transmit until receiving each acknowledgement of each packet transmitted to the terminal, the receive window value being reported from the terminal, and set the congestion window value to a first value when volume of packets stored in the transmission buffer is equal to or larger than a threshold value and to a second value that is not less than the received window value larger than the first value when volume of packets stored in the transmission buffer is smaller than the threshold value.

### CROSS-REFERENCE TO RELATED APPLICATION

This application is based upon and claims the benefit of priority of the prior Japanese Patent Application No. 2015-086289, filed on Apr. 20, 2015, the entire contents of which are incorporated herein by reference.

### FIELD

The embodiments discussed herein are related to a base station and a communication control method.

### BACKGROUND

To perform transmission control protocol (TCP) control suitable for a wireless channel established between a base station and a communication terminal in a wireless communication system, it has been proposed to use a TCP proxy in the base station. The TCP proxy terminates TCP communication between a server and the communication terminal at the base station once and then, a TCP connection is established between the base station and the communication terminal again, relaying TCP communication between the server and the base station, and between the base station and the communication terminal.

It has also been proposed to shift an application installed in the server from the server to the base station, and install the application in the base station.

Both of the base station having the TCP proxy and the base station having the application have the function of terminating TCP connection established between the base station and the communication terminal.

One example of control according to TCP is “congestion control”. In the congestion control, a transmission node, when detecting congestion on a network path to a reception node, decreases the transmission rate of the TCP packet. The congestion control is performed using “congestion window value” and “receive window value”. The window value may be also referred to as “window size”. The “congestion window value” indicates the quantity of data (that is, the number of packets) that the transmission node is allowed to transmit without transmission acknowledgement response (ACKnowledgement: ACK) from the reception node, and corresponds to the estimated quantity of data that the transmission node is allowed to transmit without congestion. The congestion window value is managed by the transmission node. The “receive window value” indicates free space of a reception buffer of the reception node, and is reported from the reception node to the transmission node. The receive window value is managed by the reception node. Then, the transmission node adjusts the quantity of transmitted data (that is, the number of transmitted packets) based on a smallest value of the congestion window value and the receive window value. In other words, the transmission node sets a smallest value of the congestion window value and the receive window value to “transmission window value”, and transmits TCP packets having the data quantity corresponding to the transmission window value to the reception node. The purpose of using the smallest value of the congestion window value and the receive window value is to suppress overflow of the reception buffer of the reception node.

Related techniques are disclosed in, for example, Japanese Laid-open Patent Publication Nos. 2006-108790, 2014-053873, and 2006-129024.

### SUMMARY

According to an aspect of the invention, a base station includes a memory configured to store a transmission buffer storing each packet to be transmitted to a terminal via a wireless channel, and a processor configured to: control volume of packets flowing in the transmission buffer based on a smaller value of a congestion window value and a receive window value, the congestion window value indicating a number of packets that the base station is allowed to transmit until receiving each acknowledgement of each packet transmitted to the terminal, the receive window value being reported from the terminal, and set the congestion window value to a first value when volume of packets stored in the transmission buffer is equal to or larger than a threshold value and to a second value that is not less than the received window value larger than the first value when volume of packets stored in the transmission buffer is smaller than the threshold value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating problems;

FIG. 2 is a view illustrating an example of configuration of a communication system in Embodiment 1;

FIG. 3 is a view illustrating an example of configuration of a terminal-side TCP unit and an LTE interface of a base station in Embodiment 1;

FIG. 4 is a view illustrating exemplary operation of the base station in Embodiment 1;

FIG. 5 is a flowchart illustrating exemplary processing of the LTE interface of the base station in Embodiment 1;

FIG. 6 is a flowchart illustrating exemplary processing of the terminal-side TCP unit of the base station in Embodiment 1;

FIGS. 7A to 7B is a view illustrating an example of a processing sequence of the communication system in Embodiment 1;

FIG. 8 is a view illustrating an example of configuration of a terminal-side TCP unit and an LTE interface of a base station in Embodiment 2;

FIG. 9 is a view illustrating exemplary operation of the base station in Embodiment 2;

FIG. 10 is a view illustrating an example of a format of a TCP header of a special ACK packet in Embodiment 2;

FIG. 11 is a flowchart illustrating exemplary processing of the base station in Embodiment 2;

FIGS. 12A to 12B is a view illustrating an example of a processing sequence of the communication system in Embodiment 2;

FIG. 13 is a view illustrating an example of configuration of a communication system in Embodiment 3;

FIG. 14 is a view illustrating an example of configuration of a communication system in Embodiment 4;

FIG. 15 is a view illustrating an example of configuration of a communication system in Embodiment 5; and

FIG. 16 is a view illustrating exemplary hardware configuration of the base station.

### DESCRIPTION OF EMBODIMENTS

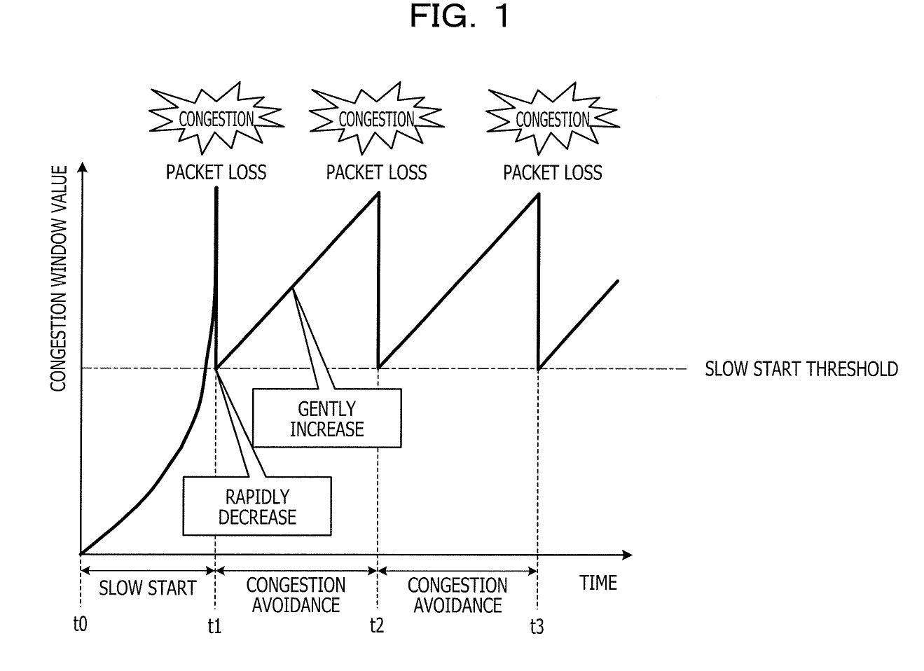

FIG. 1 is a view illustrating problems. In congestion control according to TCP, at Time t0 when starting communication with a reception node, a transmission node exponentially increases a congestion window value from an initial value at start of communication (for example, two or three packets). In other words, slow start of the congestion window value is adopted. It is assumed that the transmission node increases the congestion window value during a period from Time t0 to Time t1, causing a packet loss at Time t1. At Time t1, the transmission node determines that congestion occurred based on the packet loss and thus, the transmission node rapidly decreases the congestion window value to a slow start threshold value. Then, because congestion is avoided by the rapid decrease in the congestion window value, the transmission node starts to gently increase the congestion window value from the slow start threshold value as the initial value at Time t1. Because of the gentle increase in the congestion window value from Time t1, congestion is avoided during a period from Time t1 to Time t2. It is assumed that the transmission node gently increases the congestion window value during a period from Time t1 to Time t2, causing a packet loss again at Time t2. At Time t2, the transmission node determines that congestion occurred based on the packet loss and thus, rapidly decreases the congestion window value to the slow start threshold value again. Operation period from Time t2 to Time t3 is the same as that from Time t1 to Time t2.

However, when the congestion window value gently increases after congestion avoidance, the transmission rate also gently increases after congestion avoidance, lowering throughput.

The disclosed technique is devised in consideration of the above situation, and its object is to increase throughput.

Embodiments of a base station and a communication control method of this application will be described below with reference to drawings. The embodiments are not intended to limit the base station and the communication control method of this disclosure. Constituents having the same function and steps performing the same processing in the embodiments are given the same reference numerals, and redundant description thereof is omitted.

### Embodiment 1

### <Exemplary Configuration of Communication System>

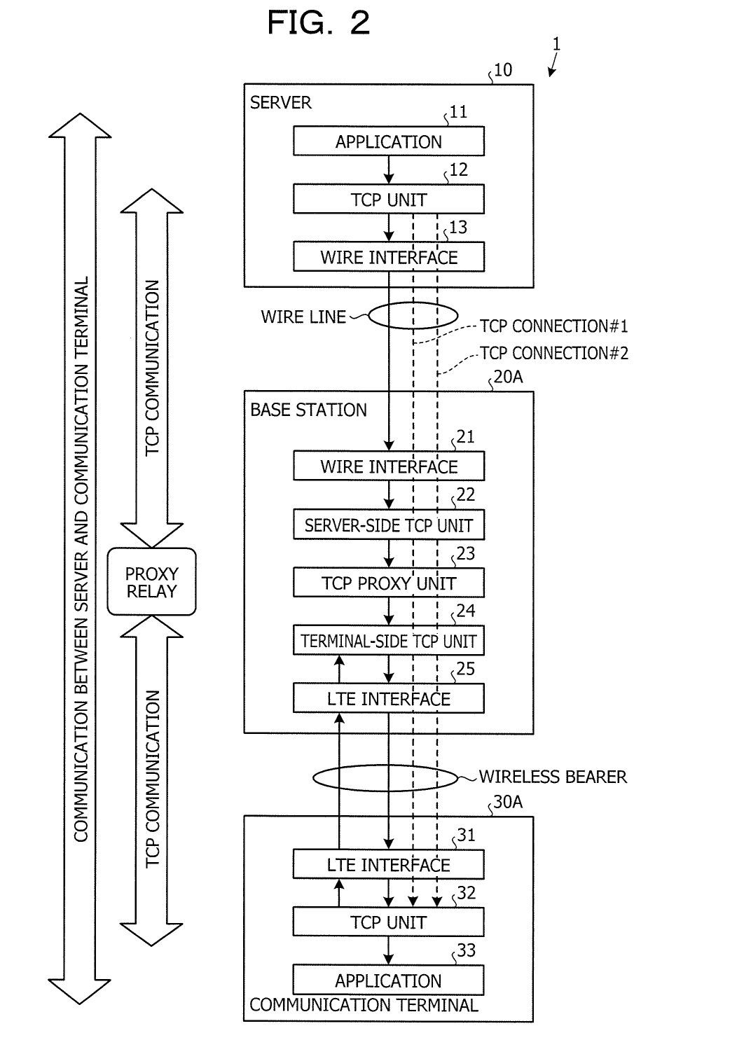

FIG. 2 is a view illustrating an example of configuration of a communication system in Embodiment 1. In FIG. 2, the communication system 1 includes a server 10, a base station 20A, and a communication terminal 30A. The server 10 is connected to the base station 20A via a wire line. The wire line is, for example, Ethernet (registered trademark). The base station 20A is connected to the communication terminal 30A via a wireless bearer specified in Long Term Evolution (LTE) communication standard. The wireless bearer specified in the LTE communication standard is an example of a wireless logical line.

A TCP connection relayed by the base station 20A is established between the server 10 and the communication terminal 30A. In FIG. 2, two TCP connections of a TCP connection #1 and a TCP connection #2 are established.

That is, the server 10 TCP-communicates with the base station 20A via the wire line using the TCP connections. The base station 20A TCP-communicates with the communication terminal 30A via the wireless bearer using the TCP connections. The base station 20A proxy-relays TCP communication between the server 10 and the base station 20A to TCP communication between the base station 20A and the communication terminal 30A. Accordingly, the server 10 communicates with the communication terminal 30A via the base station 20A. One or more wireless bearers are prepared for one communication terminal 30A, and a plurality of TCP connections established between the server 10 and the communication terminal 30A each are collected in any wireless bearer. In FIG. 2, one wireless bearer is prepared for the communication terminal 30A.

### <Exemplary Configuration of Server>

In FIG. 2, the server 10 includes an application 11, a TCP unit 12, and a wire interface 13.

The application 11 generates application data (hereinafter may be referred to as “app-data”), and outputs the generated app-data to the TCP unit 12.

The TCP unit 12 adds a TCP header to the app-data received from the application 11 to create a TCP packet, and outputs the created TCP packet to the wire interface 13.

The wire interface 13 transmits the TCP packet received from the TCP unit 12 to the base station 20A.

### <Exemplary Configuration of Base Station>

In FIG. 2, the base station 20A includes a wire interface 21, a server-side TCP unit 22, a TCP proxy unit 23, a terminal-side TCP unit 24, and an LTE interface 25.

The wire interface 21 receives the TCP packet transmitted from the server 10, and outputs the received TCP packet to the server-side TCP unit 22.

The server-side TCP unit 22 deletes the TCP header from the TCP packet received from the wire interface 21 to acquire the app-data, and outputs the acquired app-data to the TCP proxy unit 23.

The TCP proxy unit 23 outputs the app-data received from the server-side TCP unit 22 to the terminal-side TCP unit 24.

The terminal-side TCP unit 24 adds the TCP header to the app-data received from the TCP proxy unit 23 to create a TCP packet, and outputs the created TCP packet to the LTE interface 25. The terminal-side TCP unit 24 receives an ACK packet received by the LTE interface 25 from the LTE interface 25.

The LTE interface 25 executes wireless channel processing according to an LTE communication mode, and transmits the TCP packet received from the terminal-side TCP unit 24 to the communication terminal 30A. The transmission rate from the LTE interface 25 to the communication terminal 30A is controlled for each wireless bearer (in the unit of wireless bearer). The LTE interface 25 outputs the ACK packet received from the communication terminal 30A to the terminal-side TCP unit 24.

### <Exemplary Configuration of Communication Terminal>

In FIG. 2, the communication terminal 30A includes an LTE interface 31, a TCP unit 32, and an application 33.

LTE interface 31 performs wireless channel processing according to the LTE communication mode, receives the TCP packet transmitted from the base station 20A, and outputs the received TCP packet to the TCP unit 32. The LTE interface 31 transmits the ACK packet received from the TCP unit 32 to the base station 20A.

The TCP unit 32 deletes the TCP header from the TCP packet received from the LTE interface 31 to acquire app-data, and outputs the acquired app-data to the application 33. The TCP unit 32 generates an ACK packet for the TCP packet received from the LTE interface 31, and outputs the generated ACK packet to the LTE interface 31. The TCP unit 32 has a reception buffer for temporarily storing the received packet, in each TCP connection. That is, one reception buffer is used for one TCP connection. The TCP unit 32 monitors free space of the reception buffer, and generates the ACK packet including the receive window value. The TCP unit 32 generates the ACK packet including the receive window value, reporting the receive window value to the base station 20A. Since the ACK packet is generated in each TCP connection, the receive window value is calculated in each TCP connection.

The application 33 operates using the app-data received from the TCP unit 32.

### <Exemplary Configuration of Terminal-Side TCP Unit and LTE Interface in Base Station>

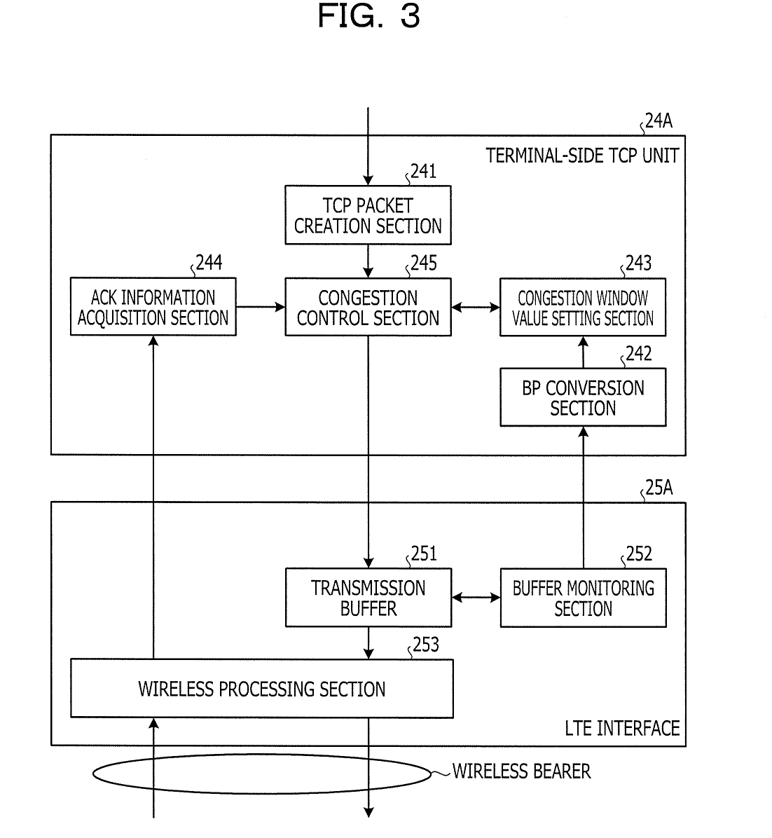

FIG. 3 is a view illustrating an example of configuration of the terminal-side TCP unit and the LTE interface of the base station in Embodiment 1. A terminal-side TCP unit 24A in FIG. 3 corresponds to the terminal-side TCP unit 24 in FIG. 2, and an LTE interface 25A in FIG. 3 corresponds to the LTE interface 25 in FIG. 2.

In FIG. 3, the terminal-side TCP unit 24A includes a TCP packet creation section 241, a back pressure (BP) conversion section 242, a congestion window value setting section 243, an ACK information acquisition section 244, and a congestion control section 245. The LTE interface 25A includes a transmission buffer 251, a buffer monitoring section 252, and a wireless processing section 253.

TCP packet creation section 241 receives app-data from the TCP proxy unit 23 (FIG. 2). The app-data is received in each TCP connection. The TCP packet creation section 241 adds the TCP header to the app-data received from the TCP proxy unit 23 to create a TCP packet, and outputs the created TCP packet to the congestion control section 245. The TCP packet is created in each TCP connection.

The BP conversion section 242 converts a BP signal received from the buffer monitoring section 252 (BP signal for each wireless bearer) into a BP signal in each TCP connection (in the unit of TCP connection). The BP conversion section 242 outputs the converted BP signal to the congestion window value setting section 243. The BP signal (back pressure signal) refers to a signal to report overflow of the transmission buffer (specifically, a state in which packet retention volume in the transmission buffer exceeds a threshold value).

When receiving the BP signal (BP signal in each TCP connection) from the BP conversion section 242, the congestion window value setting section 243 sets the congestion window value to 0 (zero). When receiving no BP signal from the BP conversion section 242, the congestion window value setting section 243 sets the congestion window value to a value that is equal to or larger than the receive window value. The congestion window value setting section 243 outputs the set congestion window value to the congestion control section 245. The congestion window value is set in each TCP connection (in the unit of TCP connection).

The ACK information acquisition section 244 acquires a receive window value from the ACK packet received from the wireless processing section 253, and outputs the acquired receive window value to the congestion control section 245. Since the ACK packet is received in each TCP connection, the receive window value is acquired in each TCP connection.

The congestion control section 245 outputs the receive window value received from the ACK information acquisition section 244 to the congestion window value setting section 243. The congestion control section 245 outputs the TCP packet received from the TCP packet creation section 241 to the transmission buffer 251. The congestion control section 245 controls the “transmission window value” in outputting the TCP packet, thereby controlling inflow volume of the TCP packet received from the TCP packet creation section 241 to the transmission buffer 251. The transmission window value refers to the number of TCP packets that may be sent to the transmission buffer 251. The congestion control section 245 sets a smallest value of the congestion window value received from the congestion window value setting section 243 and the receive window value received from the ACK information acquisition section 244 to the transmission window value. The transmission window value is set in each TCP connection.

The transmission buffer 251 temporarily stores the TCP packet received from the congestion control section 245. The transmission buffer 251 is prepared for each wireless bearer, and one transmission buffer 251 is used for one wireless bearer.

The buffer monitoring section 252 monitors the number of TCP packets stored in the transmission buffer 251, that is, TCP packet retention volume in the transmission buffer 251. The buffer monitoring section 252 generates the BP signal when the TCP packet retention volume in the transmission buffer 251 is equal to or larger than a threshold value TH, and outputs the generated BP signal to the BP conversion section 242. On the contrary, the buffer monitoring section 252 does not generate the BP signal when the TCP packet retention volume in the transmission buffer 251 is less than the threshold value TH, and does not output the BP signal to the BP conversion section 242.

The reason why the congestion window value is gently increased in FIG. 1 is a plurality of relay nodes may be present on the network path between the transmission node and the reception node. That is, each of the relay nodes has the transmission buffer that accumulates transmitted packets therein, and when the transmission buffer is filled with the packets and overflows, a packet loss occurs. When the transmission buffer overflows in one relay node, packet retention volume in the transmission buffers in other relay nodes is likely to be high. Therefore, in the case where a plurality of relay nodes are present on the network path, a packet loss occurs at the transmission rate that is higher than the bandwidth of the network path. However, it is difficult for the transmission node to grasp the packet retention volume of the transmission buffer in each relay node on the network path. Thus, in FIG. 1, to avoid frequent packet losses due to overflow of the buffers in the relay nodes, the transmission node gently increases the congestion window value.

On the contrary, due to absence of the relay node, the base station 20A does not have to consider buffer retention in the relay node. Because the base station 20A has only to consider the transmission buffer 251 of its own, the base station 20A may grasp the TCP packet retention volume in the transmission buffer 251 without waiting a response from the communication terminal, and control the congestion window value according to the grasped retention volume, thereby suppressing buffer overflow in the transmission buffer 251.

Using the threshold value TH at which the TCP packet retention volume in the transmission buffer 251 does not overflow, the congestion window value setting section 243 sets the congestion window value to 0 (zero) when the TCP packet retention volume is equal to or larger than the threshold value. The congestion window value setting section 243 sets the congestion window value to a value that is equal to or larger than the receive window value when the TCP packet retention volume in the transmission buffer 251 is less than the threshold value TH. In this manner, the base station 20A may rapidly adjust the packet inflow volume to the transmission buffer to the number of packets that may be received on the reception side (that is, the communication terminal), reducing the packet loss due to buffer overflow and suppressing a decrease in throughput after congestion avoidance.

The wireless processing section 253 executes wireless channel processing according to the LTE communication mode. The wireless processing section 253 reads a TCP packet from the transmission buffer 251, creates a wireless frame including the read TCP packet, applying predetermined wireless transmission processing to the created wireless frame, and transmits the wireless frame subjected to the wireless transmission processing to the communication terminal 30A (FIG. 2). That is, the wireless processing section 253 reads TCP packets stored in the transmission buffer 251 from the transmission buffer 251, when transmitting them to the wireless bearer. Reading of the TCP packets from the transmission buffer 251 is performed, for example, depending on the congestion state in the wireless bearer. In other words, when it is determined that no congestion has occurred in the wireless bearer, the TCP packets are sequentially read from the transmission buffer 251, and when it is determined that congestion has occurred in the wireless bearer, reading of the TCP packets from the transmission buffer 251 is stopped. The wireless processing section 253 receives an ACK packet from the communication terminal 30A, applies predetermined wireless reception processing to the received ACK packet, and outputs the ACK packet subjected to the wireless reception processing to the ACK information acquisition section 244. The ACK packet is received in each TCP connection. The ACK packet in each TCP connection includes the receive window value reported from the communication terminal 30A.

The BP conversion section 242 may be included in the LTE interface 25A rather than the terminal-side TCP unit 24A.

### <Exemplary Operation of Base Station>

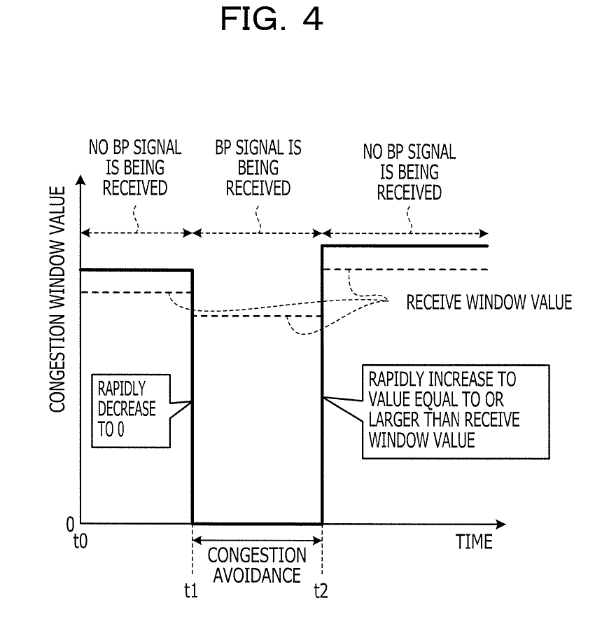

FIG. 4 is a view illustrating exemplary operation of the base station in Embodiment 1.

As illustrated in FIG. 4, the congestion window value setting section 243 sets the congestion window value to a value that is equal to or larger than the receive window value, when not receiving the BP signal from the BP conversion section 242, that is, the TCP packet retention volume in the transmission buffer 251 is less than the threshold value TH. On the contrary, the congestion window value setting section 243 sets the congestion window value to 0 (zero), when receiving the BP signal from the BP conversion section 242, that is, the TCP packet retention volume in the transmission buffer 251 is equal to or larger than the threshold value TH. In other words, the congestion window value setting section 243 decreases the congestion window value to 0, when the TCP packet retention volume in the transmission buffer 251 becomes equal to or larger than the threshold value TH. The congestion window value setting section 243 sets the congestion window value to a value that is larger than 0 and not less than the receive window value, when the TCP packet retention volume in the transmission buffer 251 becomes less than the threshold value TH as a result of a decrease in the congestion window value. For example, the congestion window value setting section 243 rapidly decreases the congestion window value to 0 at Time t1 when the TCP packet retention volume in the transmission buffer 251 becomes equal to or larger than the threshold value TH. Note that 0 (zero) is an example of the predetermined value. On the contrary, at Time t2 when the TCP packet retention volume in the transmission buffer 251 becomes less than the threshold value TH, the congestion window value setting section 243 rapidly increases the congestion window value to a value equal to or larger than the receive window value at Time t2. In summary, the congestion control section 245 sets the transmission window value to 0 during a period from Time t1 to Time t2, and a value equal to the receive window value from Time t2 forward.

### <Exemplary Processing of LTE Interface of Base Station>

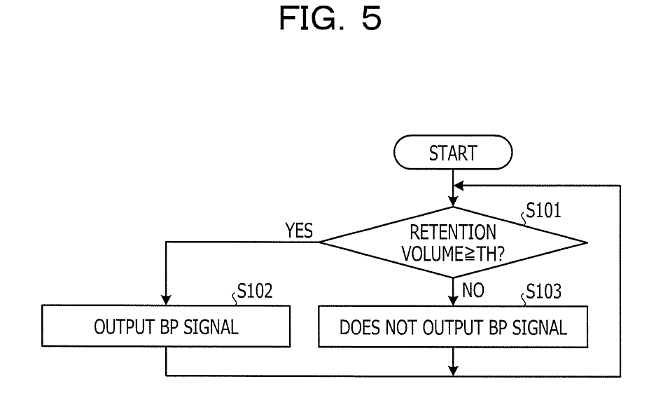

FIG. 5 is a flowchart illustrating exemplary processing of the LTE interface of the base station in Embodiment 1. The flowchart illustrated in FIG. 5 starts, for example, when the base station 20A is powered on.

In step S101, the buffer monitoring section 252 determines whether or not the TCP packet retention volume in the transmission buffer 251 is equal to or larger than the threshold value TH.

When the TCP packet retention volume in the transmission buffer 251 is equal to or larger than the threshold value TH (step S101: Yes), in step S102, the buffer monitoring section 252 outputs the BP signal to the BP conversion section 242.

When the TCP packet retention volume in the transmission buffer 251 is less than the threshold value TH (step S101: No), in step S103, the buffer monitoring section 252 does not output the BP signal.

Following the processing in step S102 or step S103, the procedure returns to step S101.

### <Exemplary Processing of Terminal-Side TCP Unit of Base Station>

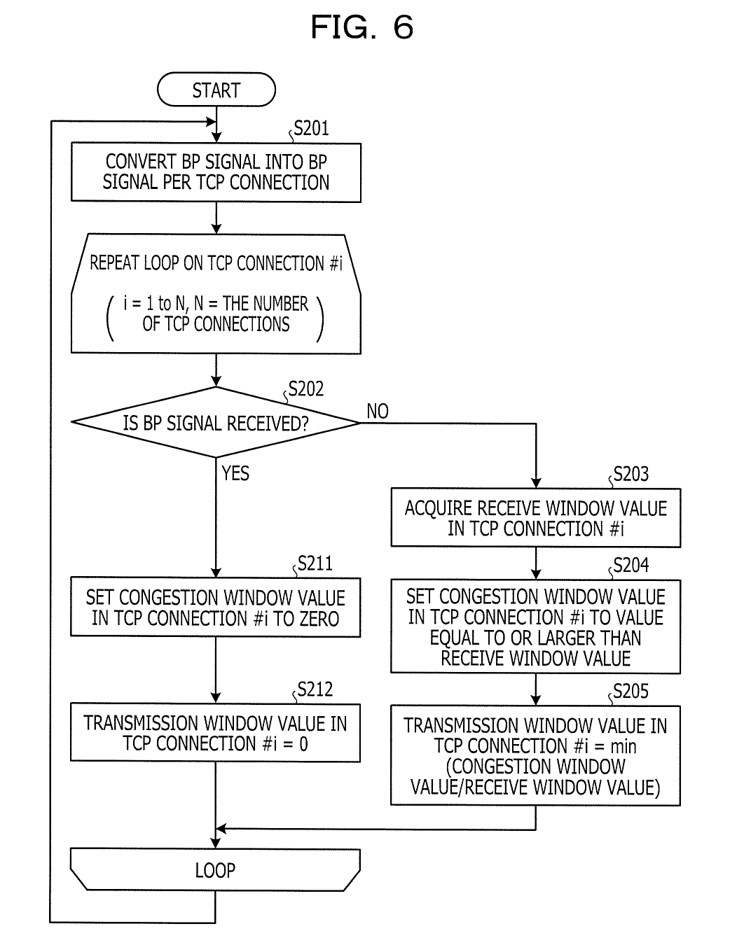

FIG. 6 is a flowchart illustrating exemplary processing of the terminal-side TCP unit of the base station in Embodiment 1. The flowchart illustrated in FIG. 6 starts, for example, when the base station 20A is powered on.

In step S201, the BP conversion section 242 converts the BP signal per wireless bearer from the buffer monitoring section 252 into the BP signal per TCP connection, and outputs the converted BP signal to the congestion window value setting section 243.

Under loop conditions, processing in steps S202, S211, and S212, or processing in steps S202, 5203, S204, and S205 is repeatedly executed. In other words, on established TCP connection #i (i=1 to N, N=the number of established TCP connections), the processing in steps S202, S211, and S212 is repeated when the determination result in step S202 is Yes, and the processing in steps S202, S203, S204, and S205 is repeated when it is No. In the example illustrated in FIG. 2, i is 2.

In step S202, the congestion window value setting section 243 determines whether or not the BP conversion section 242 inputs the BP signal to the congestion window value setting section 243.

When the BP conversion section 242 inputs the BP signal (step S202: Yes), in step S211, the congestion window value setting section 243 sets the congestion window value in TCP connection #i to 0 (zero), and outputs the set congestion window value to the congestion control section 245.

In step S212, the congestion control section 245 sets the transmission window value in TCP connection #i to a smallest value of the congestion window value in TCP connection #i and the receive window value in TCP connection #i. Thus, in step S212, the transmission window value in TCP connection #i is set to 0 (zero). When the transmission window value is set to 0, the congestion control section 245 stops outputting of the TCP packet in TCP connection #i to the transmission buffer 251. That is, when the transmission window value is set to 0, inflow of the TCP packet in TCP connection #i to the transmission buffer 251 is stopped.

When the BP conversion section 242 does not input the BP signal to the congestion window value setting section (step S202: No), in step S203, the ACK information acquisition section 244 acquires the receive window value in TCP connection #i from the ACK packet in TCP connection #i, and outputs the acquired receive window value to the congestion control section 245. The acquired receive window value is also received to the congestion window value setting section 243 via the congestion control section 245.

In step S204, the congestion window value setting section 243 sets the congestion window value in TCP connection #i to a value that is equal to or larger than the receive window value, and outputs the set congestion window value to the congestion control section 245.

In step S205, the congestion control section 245 sets the transmission window value in TCP connection #i to a smallest value of the congestion window value in TCP connection #i and the receive window value in TCP connection #i.

After the repeated processing of the loop, the procedure returns to step S201.

### <Exemplary Processing of Communication System>

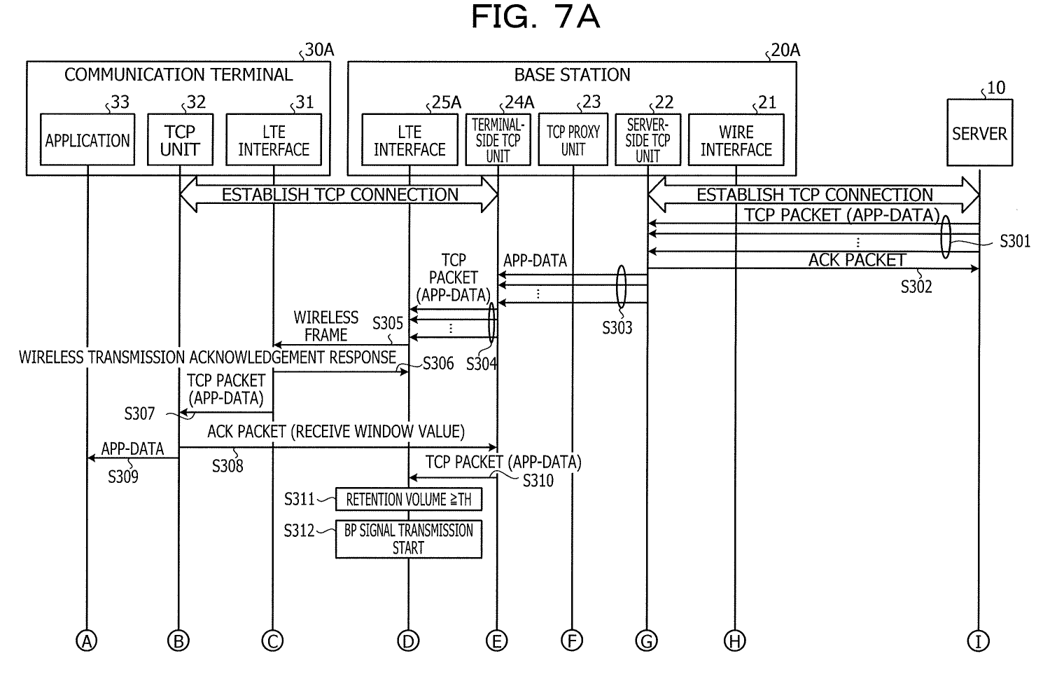

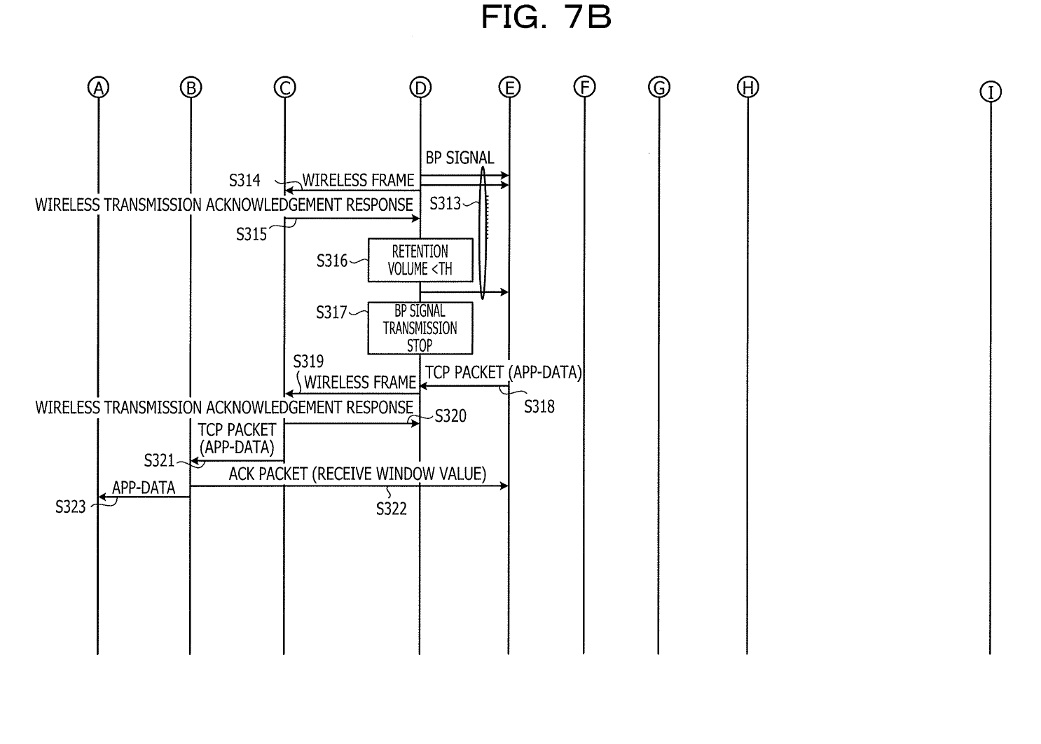

FIGS. 7A to 7B is a view illustrating an example of a processing sequence of the communication system in Embodiment 1. In FIGS. 7A to 7B, TCP connection is established between the server 10 and the base station 20A, and TCP connection is established between the base station 20A and the communication terminal 30A. The TCP connection between the server 10 and the base station 20A and the TCP connection between the base station 20A and the communication terminal 30A are established being triggered by a start of TCP communication between the server 10 and the communication terminal 30A.

In step S301, the server 10 transmits a TCP packet including app-data, and the server-side TCP unit 22 receives the TCP packet via the wire interface 21.

In step S302, the server-side TCP unit 22 transmits an ACK packet for the received TCP packet to the server 10 via the wire interface 21.

In step S303, the server-side TCP unit 22 acquires the app-data from the received TCP packet, and transmits the acquired app-data to the terminal-side TCP unit 24A via the TCP proxy unit 23.

In step S304, the terminal-side TCP unit 24A creates a TCP packet including app-data, and transmits the created TCP packet to the LTE interface 25A. The LTE interface 25A stores the received TCP packet in the transmission buffer 251 of the LTE interface 25A.

In step S305, the LTE interface 25A reads a TCP packet from the transmission buffer 251, creates a wireless frame including the read TCP packet, and applies predetermined wireless transmission processing to the created wireless frame. The LTE interface 25A transmits the wireless frame subjected to the wireless transmission processing to the communication terminal 30A via the wireless channel (wireless bearer). The LTE interface 31 of the communication terminal 30A receives the wireless frame transmitted from the LTE interface 25A.

In step S306, the LTE interface 31 transmits “transmission acknowledgement response in a wireless layer (wireless transmission acknowledgement response)” indicating that the TCP packet has reached the LTE interface 31 to the base station 20A.

In step S307, the LTE interface 31 transmits the acquired TCP packet from the wireless frame to the TCP unit 32, and the TCP unit 32 receives the TCP packet. The TCP packet includes app-data.

In step S308, the TCP unit 32 transmits “transmission acknowledgement response in a TCP layer (ACK packet)” indicating that the TCP packet has reached the TCP unit 32 to the base station 20A via the LTE interface 31. The ACK packet includes the receive window value of the communication terminal 30A. The ACK packet is received by the terminal-side TCP unit 24A via the LTE interface 25A of the base station 20A. The terminal-side TCP unit 24A acquires the receive window value from the ACK packet.

In step S309, the TCP unit 32 transmits the app-data acquired from the TCP packet to the application 33.

Through the processing in step S301 to S309, a series of transmission and reception between the base station 20A and the communication terminal 30A of one TCP packet is completed.

In step S310, the terminal-side TCP unit 24A of the base station 20A transmits a TCP packet including app-data to the LTE interface 25A. The LTE interface 25A stores the received TCP packet in the transmission buffer 251 of the LTE interface 25A.

In step S311, the LTE interface 25A detects that the TCP packet retention volume in the transmission buffer 251 is equal to or larger than the threshold value TH, that is, occurrence of congestion in the wireless channel (wireless bearer).

In step S312, the LTE interface 25A that detects occurrence of congestion in the wireless channel starts to transmit the BP signal to the terminal-side TCP unit 24A.

In step S313, the LTE interface 25A continues to transmit the BP signal to the terminal-side TCP unit 24A. Because the terminal-side TCP unit 24A sets the congestion window value to 0 (zero) while the BP signal is being transmitted, transmission of a TCP packet to the transmission buffer 251 is temporarily stopped. This may stop inflow of the TCP packet to the transmission buffer 251, avoiding congestion due to packet overflow in the transmission buffer.

Processing in step S314 and 5315 is the same as the processing in step S305 and S306, and thus, description thereof is omitted.

In step S316, the LTE interface 25A reads the TCP packet from the transmission buffer 251 in step S314, thereby detecting that the TCP packet retention volume in the transmission buffer 251 becomes less than the threshold value TH. That is, the LTE interface 25A detects release of congestion in the wireless channel (wireless bearer).

In step S317, the LTE interface 25A that detects release of congestion in the wireless channel stops transmission of the BP signal to the terminal-side TCP unit 24A. Because transmission of the BP signal is stopped, the terminal-side TCP unit 24A sets the congestion window value to a value that is larger than the predetermined value and is equal to or larger than the receive window value. When the congestion window value is set to be equal to or larger than the receive window value, the terminal-side TCP unit 24A sets the transmission window value to be equal to the receive window value. As a result, the terminal-side TCP unit 24A restarts transmission of the TCP packet to the transmission buffer 251 with inflow volume corresponding to the receive window value. This restarts flowing of the TCP packet to the transmission buffer 251.

In step S318, the terminal-side TCP unit 24A transmits the TCP packet including app-data to the LTE interface 25A. The LTE interface 25A stores the received TCP packet in the transmission buffer 251 of the LTE interface 25A.

Processing in step S319 to S323 is the same as the processing in step S305 to S309 and thus, description thereof is omitted.

As described above, in Embodiment 1, the base station 20A includes the transmission buffer 251, the congestion control section 245, and the congestion window value setting section 243. The transmission buffer 251 stores the TCP packet to be transmitted from the base station 20A to the communication terminal 30A via the wireless channel. The congestion control section 245 controls the inflow volume of TCP packets to the transmission buffer 251 based on a smallest window value of the congestion window value and the receive window value reported from the communication terminal 30A. The congestion window value setting section 243 decreases the congestion window value to a predetermined value when the TCP packet retention volume in the transmission buffer 251 becomes equal to or larger than the threshold value. The congestion window value setting section 243 sets the congestion window value to a value that is larger than the predetermined value and equal to or larger than the receive window value, when the TCP packet retention volume in the transmission buffer 251 becomes less than the threshold value after the decrease in the congestion window value. The predetermined value is, for example, 0 (zero).

In this manner, when the TCP packet retention volume in the transmission buffer 251 becomes less than the threshold value, that is, congestion in the wireless channel is released, the smallest window value in the congestion control section 245 may be rapidly increased. Since the inflow volume of TCP packets to the transmission buffer 251 may be rapidly increased when congestion in the wireless channel is released, the transmission rate may be increased rapidly. Therefore, Embodiment 1 enables higher throughput.

When the TCP packet retention volume in the transmission buffer 251 becomes equal to or larger than the threshold value, that is, congestion in the wireless channel occurs, the congestion window value may be decreased to 0 (zero). Accordingly, at occurrence of congestion in the wireless channel, flow of TCP packets to the transmission buffer 251 may be stopped. Thus, during congestion in the wireless channel, accumulation of new packets in the transmission buffer 251 may be suppressed. Therefore, Embodiment 1 enables reduction of time to solve congestion.

In applying TCP to the base station 20A, the congestion window value may be readily set to a desired value. Therefore, Embodiment 1 enables the function which improves throughput to be readily implemented on the base station 20A.

The base station 20A includes the buffer monitoring section 252 and the BP conversion section 242. The buffer monitoring section 252 outputs a BP signal when the TCP packet retention volume in the transmission buffer 251 is equal to or larger than the threshold value. The BP conversion section 242 converts the BP signal outputted from the buffer monitoring section 252 into a plurality of BP signals in a plurality of TCP connections established between the base station 20A and the communication terminal 30A. The congestion window value setting section 243 sets the congestion window value in each of TCP connections based on each of the plurality of BP signals of the plurality of TCP connections.

In this manner, inflow volume of TCP packets to the transmission buffer 251 may be controlled in each TCP connection.

The TCP packet is an example of a packet transmitted from the base station to the communication terminal. The TCP connection is an example of a connection established between the server and the base station, or between the base station and the communication terminal. This also applies to following embodiments.

### Embodiment 2

Embodiment 2 is different from Embodiment 1 (FIG. 3) in exemplary configuration of a terminal-side TCP unit and a LTE interface of a base station.

### <Exemplary Configuration of Terminal-Side TCP Unit and LTE Interface in Base Station>

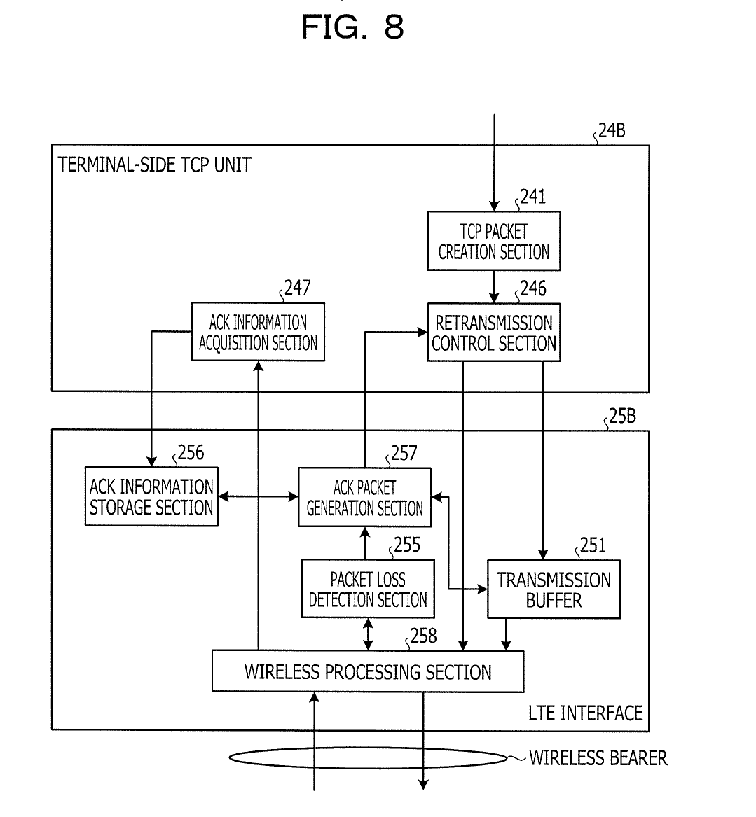

FIG. 8 is a view illustrating an example of configuration of a terminal-side TCP unit and an LTE interface of a base station in Embodiment 2. A terminal-side TCP unit 24B in FIG. 8 corresponds to the terminal-side TCP unit 24 in FIG. 2, and a LTE interface 25B in FIG. 8 corresponds to the LTE interface 25 in FIG. 2.

In FIG. 8, the terminal-side TCP unit 24B includes a TCP packet creation section 241, retransmission control section 246, and an ACK information acquisition section 247. The LTE interface 25B includes a transmission buffer 251, a packet loss detection section 255, an ACK information storage section 256, an ACK packet generation section 257, and a wireless processing section 258.

TCP packet creation section 241 receives app-data from the TCP proxy unit 23 (FIG. 2). The app-data is received in each TCP connection. The TCP packet creation section 241 adds a TCP header to the received app-data from the TCP proxy unit 23 to create a TCP packet, and outputs the created TCP packet to the retransmission control section 246. The TCP packet is created in each TCP connection.

At first transmission of a TCP packet having any sequence number, the retransmission control section 246 outputs the TCP packet received from the TCP packet creation section 241 to the transmission buffer 251. The retransmission control section 246 performs retransmission control of the TCP packet based on the ACK packet received from the ACK packet generation section 257. At retransmission of the TCP packet having the same sequence number as that of the TCP packet at the first transmission, the retransmission control section 246 outputs the TCP packet received from the TCP packet creation section 241 to the wireless processing section 258.

The ACK information acquisition section 247 acquires an ACK number and the receive window value from the ACK packet received from the wireless processing section 258, as ACK information, and outputs the ACK information including the acquired ACK number and receive window value to the ACK information storage section 256. The ACK number is set by the TCP unit 32 of the communication terminal 30A based on the sequence number of the TCP packet that has reached the TCP unit 32. Since the ACK packet is received in each TCP connection, the ACK number is acquired in each TCP connection.

The ACK information storage section 256 stores the ACK number and the receive window value received from the ACK information acquisition section 247, as the ACK information, in each TCP connection.

The transmission buffer 251 temporarily stores the TCP packet received from the retransmission control section 246. The transmission buffer 251 is prepared for each wireless bearer, and one transmission buffer 251 is used for one wireless bearer.

The packet loss detection section 255 detects a packet loss in the wireless channel (wireless bearer), and outputs the sequence number of the lost packet to the ACK packet generation section 257. For example, the packet loss detection section 255 detects the packet loss in the wireless channel based on the number of times the wireless processing section 258 retransmitted the TCP packet having the same sequence number.

The ACK packet generation section 257 generates an ACK packet that enables the retransmission control section 246 of the terminal-side TCP unit 24B to identify a lost packet in the wireless channel, and outputs the generated ACK packet to the retransmission control section 246. Hereinafter, the ACK packet generated by the ACK packet generation section 257 may be referred to as “special ACK packet”.

The wireless processing section 258 executes the wireless channel processing according to the LTE communication mode. The wireless processing section 258 reads a TCP packet from the transmission buffer 251, and creates a wireless frame including the read TCP packet. The wireless processing section 258 applies predetermined wireless transmission processing to the created wireless frame, and transmits the wireless frame subjected to the wireless transmission processing to the communication terminal 30A (FIG. 2). That is, the wireless processing section 258 reads the TCP packet stored in the transmission buffer 251 from the transmission buffer 251, and transmits the read TCP packet to the wireless bearer. The wireless processing section 258 creates a wireless frame including the TCP packet received from the retransmission control section 246, applies predetermined wireless transmission processing to the created wireless frame, and transmits the wireless frame subjected to the wireless transmission processing to the communication terminal 30A. The wireless processing section 258 receives an ACK packet from the communication terminal 30A, applies predetermined wireless reception processing to the received ACK packet, and outputs the ACK packet subjected to the wireless reception processing to the ACK information acquisition section 247. The ACK packet is received in each TCP connection. The ACK packet received in each TCP connection includes the ACK number reported from the communication terminal 30A. The wireless processing section 258 retransmits the TCP packet on the wireless channel.

### <Exemplary Operation of Base Station>

The terminal-side TCP unit 24B and the LTE interface 25B retransmit the TCP packet as follows. The TCP packet is retransmitted in each TCP connection. Hereinafter the sequence number of the TCP packet may be referred to as “SN”.

When determining that a transmitted wireless frame has not reached the communication terminal 30A due to degradation of the wireless channel or the like, the wireless processing section 258 retransmits the wireless frame. The wireless processing section 258 determines that the wireless frame has not reached the communication terminal 30A, for example, when the wireless processing section 258 has not received the transmission acknowledgement response in the wireless layer, (that is, wireless transmission acknowledgement response) from the communication terminal 30A. For example, the wireless processing section 258 determines that the wireless frame has not reached the communication terminal 30A, when the wireless processing section 258 has received a negative acknowledgement (NACK) from the communication terminal 30A indicating that the communication terminal 30A has not been able to receive the wireless frame. It is determined whether or not the wireless frame has not reached the communication terminal 30A according to the standard specification of the wireless channel (for example, the standard specification of LTE). The wireless processing section 258 grasps the sequence number of the TCP packet that has reached the LTE interface 31 of the communication terminal 30A, based on the wireless transmission acknowledgement response received from the communication terminal 30A. Here, assume that the sequence numbers of the TCP packets that have reached the LTE interface 31 of the communication terminal 30A (hereinafter may be referred to as “reached packet number”) are “3” and “4”.

The packet loss detection section 255 detects the packet loss in the wireless channel, for example, when the number of times of retransmission of the wireless frame created from the TCP packet having the same sequence number by the wireless processing section 258 reaches a predetermined maximum retransmission times. The predetermined maximum retransmission times is determined, for example, according to the standard specification of the wireless channel (standard specification of LTE). When determining occurrence of the packet loss in the wireless channel, the packet loss detection section 255 acquires the sequence number of the TCP packet lost in the wireless channel (hereinafter may be referred to as “lost packet number”) and the reached packet number from the wireless processing section 258. The packet loss detection section 255 outputs the acquired lost packet number and reached packet number to the ACK packet generation section 257. Here, assume that the lost packet number is “5”.

The ACK packet generation section 257 that receives the reached packet number=3, 4 and the lost packet number=5 received from the packet loss detection section 255 acquires the ACK number stored in the ACK information storage section 256 from the ACK information storage section 256. Here, assume that the ACK information storage section 256 stores the ACK number up to “3”. The ACK number=3 is an example of the ACK number received from the communication terminal 30A. The sequence number of the TCP packet that has reached the TCP unit 32 of the communication terminal 30A may be grasped based on the ACK number. According to the specification of TCP, the reception node sets the sequence number next to the sequence number of the received TCP packet, to the ACK number. Thus, ACK number=3 indicates that the TCP packets having the number up to SN=2 have reached the TCP unit 32 of the communication terminal 30A. The ACK packet generation section 257 acquires the receive window value stored in the ACK information storage section 256 from the ACK information storage section 256. The ACK packet generation section 257 monitors the state of the transmission buffer 251, and the sequence number of the TCP packet stored in the transmission buffer 251 (hereinafter may be referred to as “stored packet number”) is acquired from the transmission buffer 251.

Then, the ACK packet generation section 257 generates the special ACK packet based on the reached packet number, the lost packet number, the ACK number, the stored packet number, and the receive window value. The ACK packet generation section 257 outputs the generated special ACK packet to the retransmission control section 246. Here, assume that the acquired stored packet number is “6”. The ACK packet generation section 257 determines the following fact based on the reached packet number=3, 4 and the stored packet number=6. That is, the ACK packet generation section 257 determines that the TCP packets having SN=3, 4 have reached the LTE interface 31 of the communication terminal 30A, and are not stored in the transmission buffer 251. The stored packet number=6 corresponds to the sequence number next to the lost packet number=5. That is, the ACK packet generation section 257 that has acquired the stored packet number=6 determines that the TCP packet next to the lost packet is present in the transmission buffer 251.

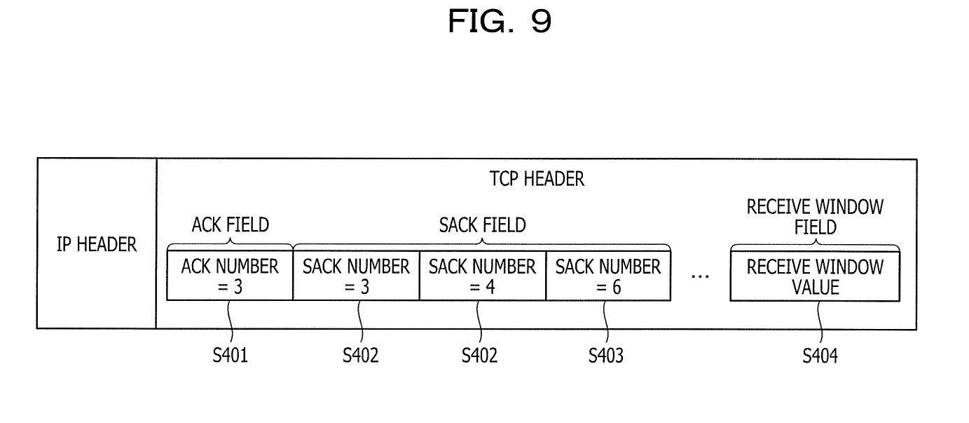

When determining that the TCP packet next to the lost packet is present in the transmission buffer 251, the ACK packet generation section 257 generates the special ACK packet as follows. FIG. 9 is a view illustrating exemplary operation of the base station in Embodiment 2. FIG. 9 illustrates a TCP header of the special ACK packet. The TCP header of the special ACK packet includes an ACK field, a selective ACK (SACK) field, and a receive window field.

The ACK packet generation section 257 sets the ACK number acquired from the ACK information storage section 256 in the ACK field. Thus, the ACK packet generation section 257 sets “ACK number=3” acquired from the ACK information storage section 256 in the ACK field (step S401).

The ACK packet generation section 257 sets the ACK number set in the ACK field (ACK number acquired from the ACK information storage section 256) to the number corresponding to “the lost packet number-1”, as SACK numbers, in the SACK field. Since the ACK number is 3 and the lost packet number is 5, the ACK packet generation section 257 sets the SACK number=3 and the SACK number=4 in the SACK field (step S402). SN=4 is an example of the sequence number of the TCP packet immediately before the TCP packet having SN=5, which is the lost packet in the wireless channel. The TCP packets having SN=3, 4 are examples of packets that have reached the LTE interface 31 of the communication terminal 30A.

The ACK packet generation section 257 sets the number of “the lost packet number+1” as the SACK number in the SACK field. Because of the lost packet number=5, the ACK packet generation section 257 sets the SACK number=6 in the SACK field (step S403). Thus, SN=6 is an example of the sequence number of the TCP packet next to the TCP packet having SN=5, which is the lost packet in the wireless channel.

The ACK packet generation section 257 sets the receive window value acquired from the ACK information storage section 256 in the receive window field (step S404).

The SACK number is the ACK that uniquely indicates which sequence number of TCP packet reaches the TCP unit 32 of the communication terminal 30A, and is selectively available. The normal ACK packet herein is generated by the communication terminal 30A on the reception side of the TCP packet. On the contrary, the special ACK packet is generated by the base station 20A on the transmission side of the TCP packet rather than the communication terminal 30A. That is, the SACK number=3, 4, 6 set to the special ACK packet artificially indicates that the TCP packets having SN=3, 4, 6 have reached the TCP unit 32 of the communication terminal 30A.

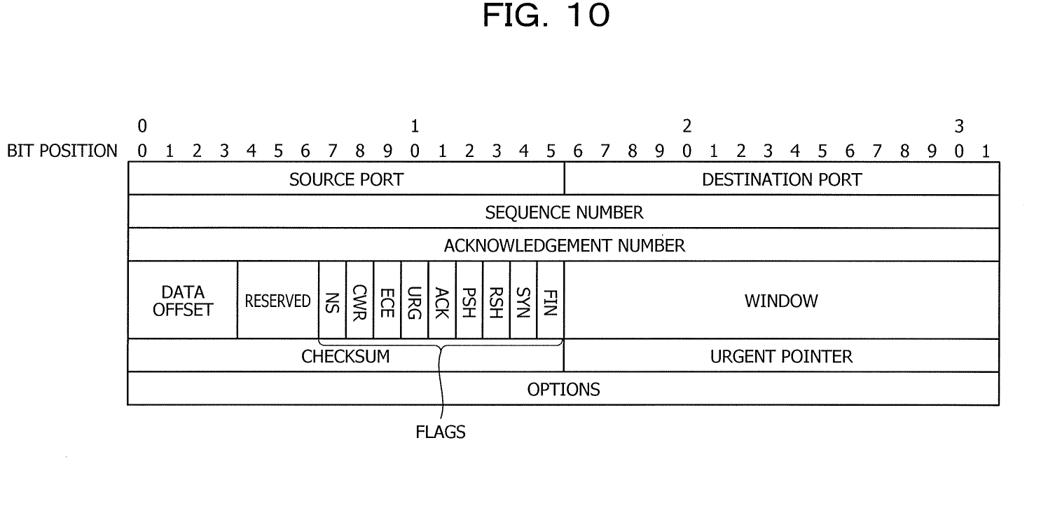

FIG. 10 illustrates an example of a format of the TCP header of the special ACK packet. FIG. 10 is a view illustrating an example of the format of the TCP header of the special ACK packet in Embodiment 2.

As illustrated in FIG. 10, the TCP header of the special ACK packet include fields for Source Port, Destination Port, Sequence Number, Acknowledgement Number, Data Offset, Reserved, Flags, Window, Checksum, Urgent Pointer, and Options. Structure of the TCP header of the special ACK packet is the same as structure of the TCP header of the normal ACK packet according to the TCP specification.

Structure of an IP (Internet Protocol) header of the special ACK packet is the same as structure of an IP header of the normal ACK packet according to the TCP specification. In other words, the IP header of the special ACK packet has fields for protocol number, source IP address, and destination IP address.

In FIG. 10, the source port number is set to Source Port, the destination port number is set to Destination Port, and the sequence number of the TCP packet is set to Sequence Number. The sequence number (ACK number) of the TCP packet next to the reached TCP packet is set to Acknowledgement Number when an ACK flag in Flags is “1 (ON)”. A head length of the TCP header is set to Data Offset, Reserved is a field reserved for future use, and each flag in Flags is a flag indicating control contents. The receive window value is set to Window, and Checksum is a field for error control. Urgent Pointer indicates the position of data for emergency processing when a URG flag in Flags is “1 (ON)”, Options is a field that may be optionally used by the user, and various TCP options are set to Options. The ACK field illustrated in FIG. 9 corresponds to Acknowledgement Number field in FIG. 10, and the receive window field illustrated in FIG. 9 corresponds to Window field in FIG. 10. SACK field illustrated in FIG. 9 is included in Options field in FIG. 10.

TCP connection is identified according to a 5-tuple set of protocol number, source IP address, and destination IP address, which are set to the IP header, and source port number and destination port number, which are set to the TCP header.

Returning to FIG. 9, the ACK packet generation section 257 outputs the special ACK packets including the ACK number=3 and the SACK number=3, 4, 6 to the retransmission control section 246. Because structure of the TCP header of the special ACK packet is the same as that of the TCP header of a normal ACK packet according to the TCP specification, the retransmission control section 246 processes the special ACK packet in the same manner as the normal ACK packet. That is, the retransmission control section 246 identifies that the lost packet is the TCP packet having SN=5 based on the ACK number=3 and the SACK number=3, 4, 6. Then, the retransmission control section 246 retransmits the TCP packet having SN=5.

The ACK packet generation section 257 sets the above-mentioned SACK number to the special ACK packet for a following reason.

To immediately report that the TCP packet having SN=5 is lost in the wireless channel to the retransmission control section 246, even before transmission of the TCP packet having SN=6, the SACK number=6 may be reported to the retransmission control section 246. The SACK number indicates that the TCP packet having SN=6 has reached the TCP unit 32 of the communication terminal 30A. By reporting the SACK number=3, 4, 6 to the retransmission control section 246, the fact that the lost packet is the TCP packet having SN=5 is artificially reported to the retransmission control section 246.

At the time when the special ACK packets having the SACK number=3, 4, 6 are received to the retransmission control section 246, the TCP packet having SN=6 has not reached the communication terminal 30A yet. Thus, there is the possibility that the TCP packet having SN=6 artificially indicated to have reached the TCP unit 32 according to the SACK number=6 is lost in the wireless channel, and in fact, has not reached the communication terminal 30A. However, according to the TCP specification, the reception node is allowed to abandon the TCP packet for which the transmission acknowledgement response has been issued to the transmission node by SACK, after the notification of the SACK to the transmission node. For this reason, considering that the TCP packet for which the transmission acknowledgement response has been issued to the transmission node by SACK is abandoned after the notification of the SACK to the transmission node, the transmission node stores such TCP packet in the transmission buffer in the TCP layer. Accordingly, the transmission buffer (not illustrated) of the terminal-side TCP unit 24B of the base station 20A stores the TCP packet having SN=6. Therefore, even if the TCP packet having SN=6 artificially indicated to have reached the TCP unit 32 with the SACK number=6 is lost in the wireless channel, the terminal-side TCP unit 24B may retransmit the TCP packet having SN=6.

That is, when receiving the SACK, the retransmission control section 246 retransmits the TCP packet based on the SACK, and also separately retransmits the TCP packet for which the transmission acknowledgement response by the ACK has not been obtained for a long time. Generally, an upper limit time set in a timer to acquire the transmission acknowledgement response by ACK is longer than the time desired to acquire the transmission acknowledgement response according to SACK. Even if the transmission acknowledgement response according to SACK has been acquired, the transmission buffer (not illustrated) of the terminal-side TCP unit 24B stores the TCP packet having the SACK number as the sequence number until the transmission acknowledgement response by ACK is acquired. Thus, if the TCP packet having SN=6 that has not reached the communication terminal 30A is lost, when the transmission acknowledgement response according to ACK on the TCP packet having SN=6 is not acquired for a predetermined time, the retransmission control section 246 retransmits the TCP packet having SN=6. Consequently, even if the TCP packet having SN=6 is lost, the TCP packet having SN=6 eventually reaches the communication terminal 30A by the retransmission. Therefore, before the TCP packet having SN=6 reaches the communication terminal 30A, the special ACK packets including the SACK number=3, 4, and 6 may be reported to the retransmission control section 246 without any problem.

The TCP packets having SN=3, 4 that have reached the LTE interface 31 of the communication terminal 30A but the reception of which has not been acknowledged by the TCP unit 32 of the communication terminal 30A may be lost before the TCP unit 32 acknowledges the reception. For example, when a failure occurs in the LTE interface 31 or the TCP unit 32, the TCP packets having SN=3, 4 may be lost. Thus, when the ACK number=5 is set in place of setting the SACK number=3, 4, the TCP packets which the base station 20A recognizes have reached the TCP unit 32 and the TCP packets which the communication terminal 30A recognizes have done so are different, and this may cause a mismatch between their recognitions. The reason is that the ACK number=5 means that the TCP unit 32 of the communication terminal 30A has acknowledged that the TCP packets up to SN=4 have reached the TCP unit 32. However, as described above, according to the TCP specification, the reception node is allowed to abandon the TCP packet for which the transmission acknowledgement response has been issued to the transmission node by SACK, after the notification of the SACK to the transmission node. For this reason, considering that the TCP packet for which the transmission acknowledgement response has been issued to the transmission node by SACK is abandoned after the notification of the SACK to the transmission node, the transmission node stores such TCP packet in the transmission buffer in the TCP layer. Therefore, even if the TCP packets having SN=3, 4 are lost before the TCP unit 32 acknowledges the reception, the situation may be covered by retransmission. Thus, when receiving the reached packet number=3, 4, the ACK packet generation section 257 sets the SACK number=3, 4 rather than the ACK number=5.

In the TCP specification, the reception node is allowed to abandon the TCP packet for which the transmission acknowledgement response has been issued to the transmission node by SACK, after the notification of the SACK to the transmission node, for a following reason, for example.

The SACK is a transmission acknowledgement response added to the TCP specification, in consideration of a possibility that the TCP packet may be uselessly retransmitted in the case the TCP specification includes only the ACK. Assume a case that the reception node has received the TCP packets having SN=100, 101, 103, but has not received the TCP packet having SN=102. In this case, it is difficult for the transmission node to determine whether or not the reception node has received the TCP packet having SN=103, only based on the ACK number=102 indicating that the TCP packets up to SN=101 have reached the reception node. Thus, with only the ACK number=102, there is a possibility that the transmission node may retransmit the TCP packets having SN=102, 103. However, since the reception node has received the TCP packet having SN=103, retransmission of the TCP packet having SN=103 is unnecessary.

On the contrary, since the SACK number=103 makes it possible for the transmission node to recognize that the reception node has received the TCP packet having SN=103, the transmission node only transmits the TCP packet having SN=102. Meanwhile, it is required that the TCP unit of the reception node passes TCP packet data to the application in the order of sequence number. For this reason, the TCP unit of the reception node passes data of the TCP packets having SN=100, 101 to the application and then, stores the TCP packet having SN=103 in the reception buffer until reception of the TCP packet having SN=102. Here, in the case where the TCP unit of the reception node receives a large number of TCP packets having SN=103 and forward before reception of the TCP packet having SN=102, the reception buffer may overflow. Thus, according to the TCP specification, to avoid overflow of the reception buffer, the reception node is allowed to abandon the TCP packet for which the transmission acknowledgement response has been issued to the transmission node by SACK (in this case, the TCP packet having SN=103) after notification of the SACK.

### <Exemplary Processing of Base Station>

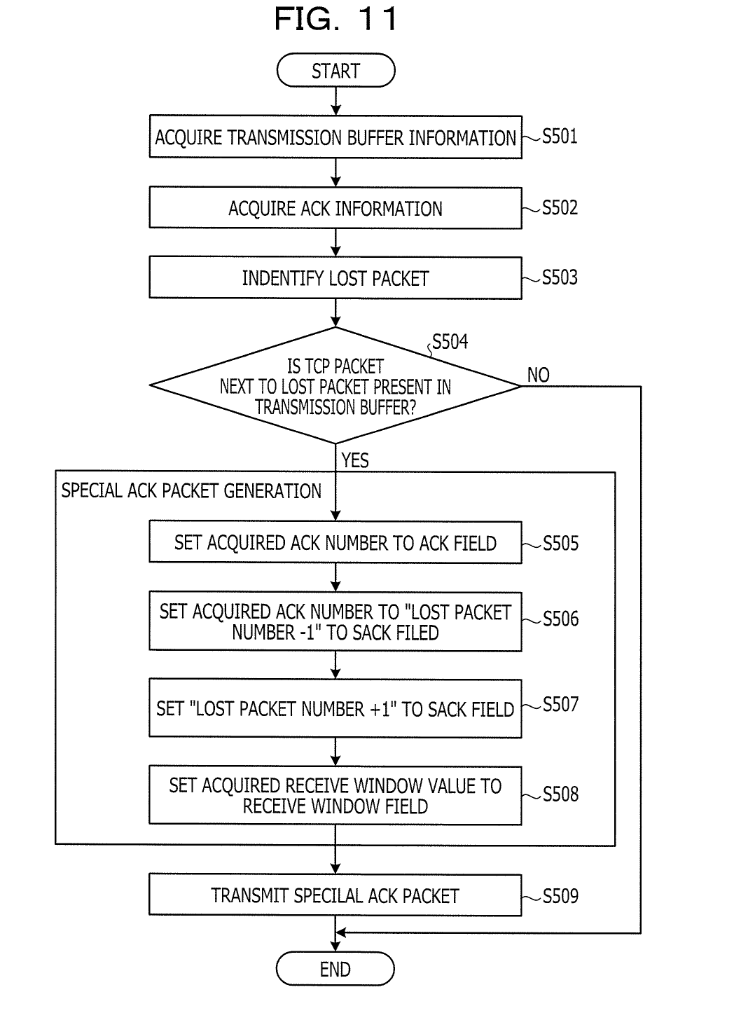

FIG. 11 is a flowchart illustrating exemplary processing of the base station in Embodiment 2. The flowchart in FIG. 11 starts, for example, when a packet loss in the wireless channel (wireless bearer) is detected.

In step S501, the ACK packet generation section 257 acquires information on the transmission buffer 251. As the information on the transmission buffer 251, the ACK packet generation section 257 acquires from the transmission buffer 251 the information that the transmission buffer 251 does not store the TCP packet corresponding to the reached packet number. As the information on the transmission buffer 251, the ACK packet generation section 257 also acquires the stored packet number from the transmission buffer 251. For example, in the above exemplary operation, the reached packet numbers are 3, 4, and the stored packet number is 6.

In step S502, the ACK packet generation section 257 acquires the ACK information stored in the ACK information storage section 256. The ACK packet generation section 257 acquires the ACK number and the receive window value as the ACK information from the ACK information storage section 256. For example, in the above exemplary operation, ACK number is 3.

In step S503, the ACK packet generation section 257 identifies a lost packet. The ACK packet generation section 257 identifies the TCP packet corresponding to the lost packet number received from the packet loss detection section 255 as the lost packet. For example, in the above exemplary operation, the lost packet number is 5.

The order of the processing in step S501 to S503 is not limited.

In step S504, the ACK packet generation section 257 determines whether or not a TCP packet next to the lost packet is present in the transmission buffer 251. That is, the ACK packet generation section 257 determines whether or not the stored packet number corresponding to the sequence number next to the lost packet number is present in the stored packet number acquired in step S501. For example, since the lost packet number=5 and the stored packet number=6 are present in the above exemplary operation, the ACK packet generation section 257 determines that the TCP packet next to the lost packet is present in the transmission buffer 251.

Here, when the ACK packet for the TCP packet that has not been outputted from the retransmission control section 246 to the transmission buffer 251 is received to the retransmission control section 246, a mismatch occurs in recognition of the retransmission control section 246. That is, if the retransmission control section 246 received the ACK packet for the untransmitted TCP packet from the retransmission control section 246, the retransmission control section 246 could not match the TCP packet to the ACK packet. The mismatch between the TCP packet and the ACK packet would cause a disorder of retransmission control in the retransmission control section 246. Thus, when the TCP packet next to the lost packet is absent in the transmission buffer 251 (step S504: No), the ACK packet generation section 257 finishes the processing without generating the special ACK packet. This suppresses the disorder of retransmission control in the retransmission control section 246.

On the contrary, when the TCP packet next to the lost packet is present in the transmission buffer 251 (step S504: Yes), the ACK packet generation section 257 executes the processing in step S505 to S508 to generate the special ACK packet.

That is, in step S505, the ACK packet generation section 257 sets the ACK number acquired in step S502 to the ACK field in the TCP header of the special ACK packet. That is, the processing in step S505 corresponds to step S401 in FIG. 9.

In step S506, the ACK packet generation section 257 sets the ACK number to the “lost packet number-1 (sequence number immediately before the lost packet number)” to the SACK field in the TCP header of the special ACK packet. That is, the processing in step S506 corresponds to the processing in step S402 in FIG. 9.

In step S507, the ACK packet generation section 257 sets the “lost packet number+1 (sequence number next to the lost packet number)” to the SACK field in the TCP header of the special ACK packet. That is, the processing in step S507 corresponds to the processing in step S403 in FIG. 9.

In step S508, the ACK packet generation section 257 sets the receive window value to the receive window field in the TCP header of the special ACK packet. That is, the processing in step S508 corresponds to step S404 in FIG. 9.

In step S509, the ACK packet generation section 257 transmits the generated special ACK packet to the retransmission control section 246 through the processing in step S505 to S508.

After the processing in step S509, the procedure is terminated.

### <Exemplary Processing of Communication System>

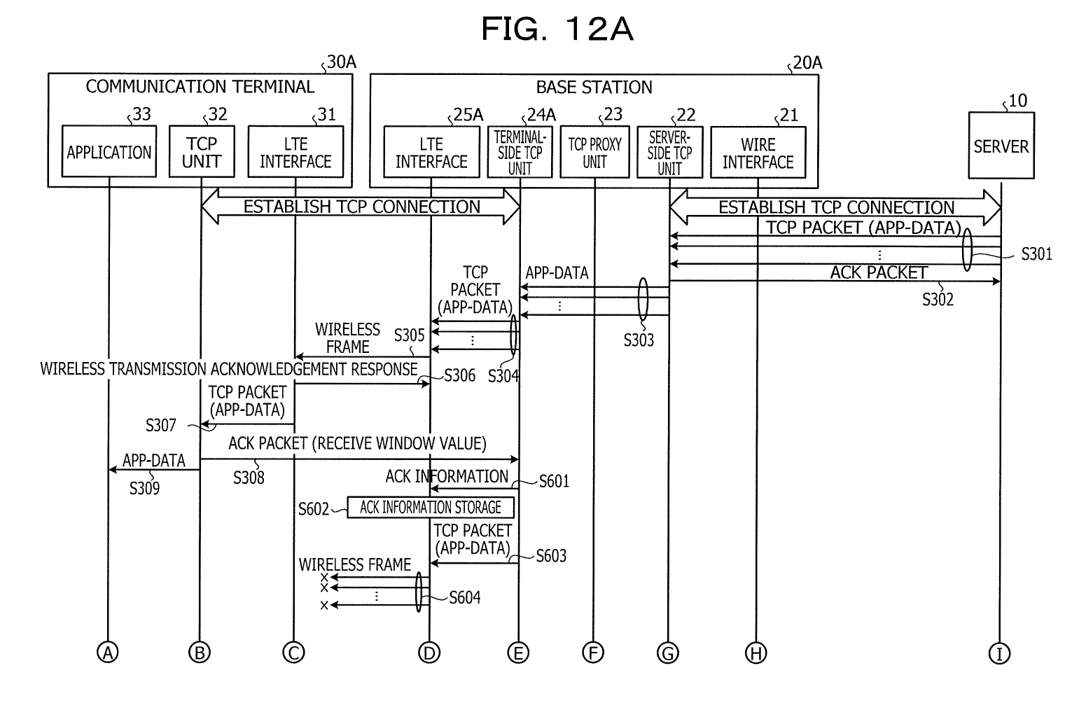

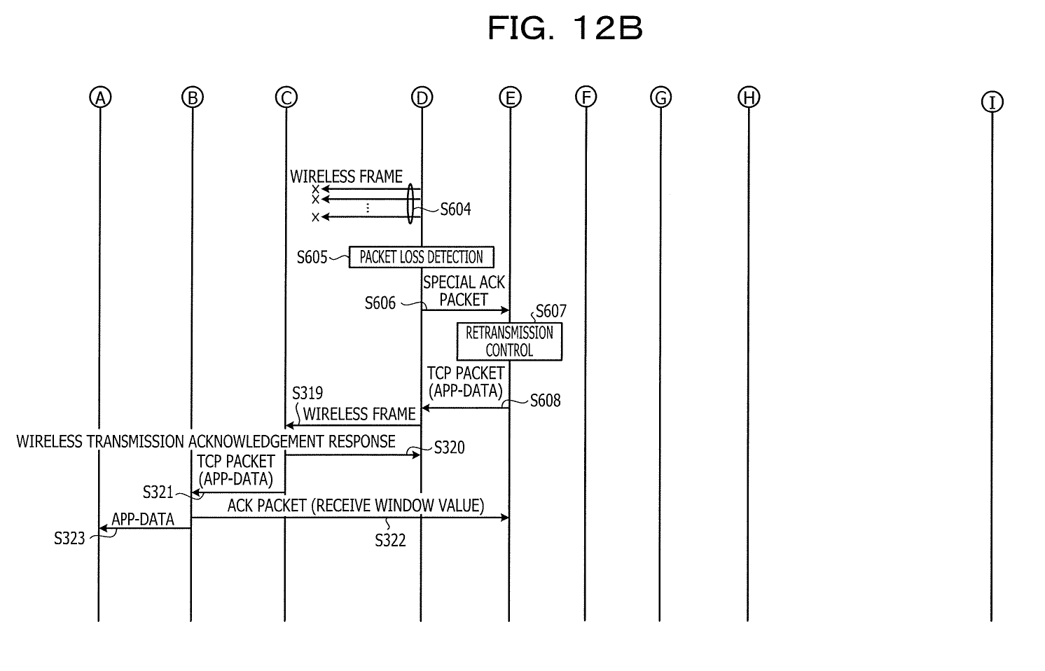

FIGS. 12A to 12B is a view illustrating an example of a processing sequence of the communication system in Embodiment 2. In FIGS. 12A to 12B, TCP connection has been established between the server 10 and the base station 20A, and TCP connection has been established between the base station 20A and the communication terminal 30A. The TCP connection between the server 10 and the base station 20A, and the TCP connection between the base station 20A and the communication terminal 30A are established being triggered by a start of TCP communication between the server 10 and the communication terminal 30A.

Processing in step S301 to S309 in FIGS. 12A to 12B is the same as that in Embodiment 1 (FIGS. 7A to 7B) and thus, description thereof is omitted.

In step S601, the terminal-side TCP unit 24B transmits ACK information including the ACK number and the receive window value to the LTE interface 25B.

In step S602, the LTE interface 25B stores the ACK information received from the terminal-side TCP unit 24B.

In step S603, the terminal-side TCP unit 24B transmits the TCP packet including app-data to the LTE interface 25B. The LTE interface 25B stores the received TCP packet in the transmission buffer 251 of the LTE interface 25B.

In step S604, the LTE interface 25B reads a TCP packet from the transmission buffer 251, creates a wireless frame including the read TCP packet, and applies predetermined wireless transmission processing to the created wireless frame. The LTE interface 25B transmits the wireless frame subjected to the wireless transmission processing to the communication terminal 30A via the wireless channel (wireless bearer). Because the wireless frame does not reach the communication terminal 30A due to degradation of the wireless channel or the like, the LTE interface 25B retransmits the wireless frame.

In step S605, the LTE interface 25B detects the packet loss in the wireless channel by knowing that the number of times of retransmission of the wireless frame has reached the predetermined maximum retransmission times.

In step S606, the LTE interface 25B that has detected the packet loss in step S605 generates the special ACK packet, and transmits the generated special ACK packet to the terminal-side TCP unit 24B.

In step S607, the terminal-side TCP unit 24B performs retransmission control of the lost TCP packet in step S604 based on contents of the special ACK packet. That is, the terminal-side TCP unit 24B that has received the special ACK packet determines retransmission of the TCP packet lost in the wireless channel without waiting the transmission acknowledgement response from the communication terminal 30A and time-out of a retransmission timer.

In step S608, the terminal-side TCP unit 24B retransmits the TCP packet including app-data to the LTE interface 25B according to the retransmission control in step S607. That is, the terminal-side TCP unit 24B transmits the same TCP packet as the TCP packet lost in the step S604 to the LTE interface 25B.

The processing in step S319 to S323 is the same as that in Embodiment 1 (FIGS. 7A to 7B) and thus, description thereof is omitted.

As described above, in Embodiment 2, the base station 20A includes the ACK packet generation section 257 and the retransmission control section 246. The ACK packet generation section 257 generates the special ACK packet, when a TCP packet is lost in the wireless channel between the base station 20A and the communication terminal 30A. The special ACK packet generated by the ACK packet generation section 257 includes the ACK number received from the communication terminal 30A, and the SACK number from the ACK number to the sequence number of the TCP packet immediately before the TCP packet lost in the wireless channel. The special ACK packet generated by the ACK packet generation section 257 includes the same SACK number as the sequence number of the TCP packet next to the TCP packet lost in the wireless channel. The retransmission control section 246 performs retransmission control of the lost TCP packet, based on the special ACK packet generated by the ACK packet generation section 257.

In this manner, the retransmission control section 246 may identify a lost packet based on the special ACK packet generated by the ACK packet generation section 257. For this reason, the retransmission control section 246 may identify a lost packet without waiting the transmission acknowledgement response from the communication terminal 30A, and retransmit the identified lost packet. That is, the retransmission control section 246 may retransmit the lost packet before reception of the transmission acknowledgement response on the lost packet from the communication terminal 30A. Therefore, Embodiment 2 suppresses a decrease in throughput due to packet loss.

The ACK packet generation section 257 generates the special ACK packet including the SACK number for the retransmission control section 246 that operates according to the TCP specification. Therefore, Embodiment 2 enables the function which suppresses a decrease in throughput to be readily implemented on the base station 20A.

The base station 20A has the transmission buffer 251. The transmission buffer 251 stores the TCP packet to be transmitted from the base station 20A to the communication terminal 30A via the wireless channel. The ACK packet generation section 257 generates the special ACK packet when the transmission buffer 251 stores the TCP packet next to the TCP packet lost in the wireless channel.

In this manner, consistency between the TCP packet and the special ACK packet is kept in the retransmission control section 246, suppressing disorder of retransmission control in the retransmission control section 246.

### Embodiment 3

### <Exemplary Configuration of Communication System>

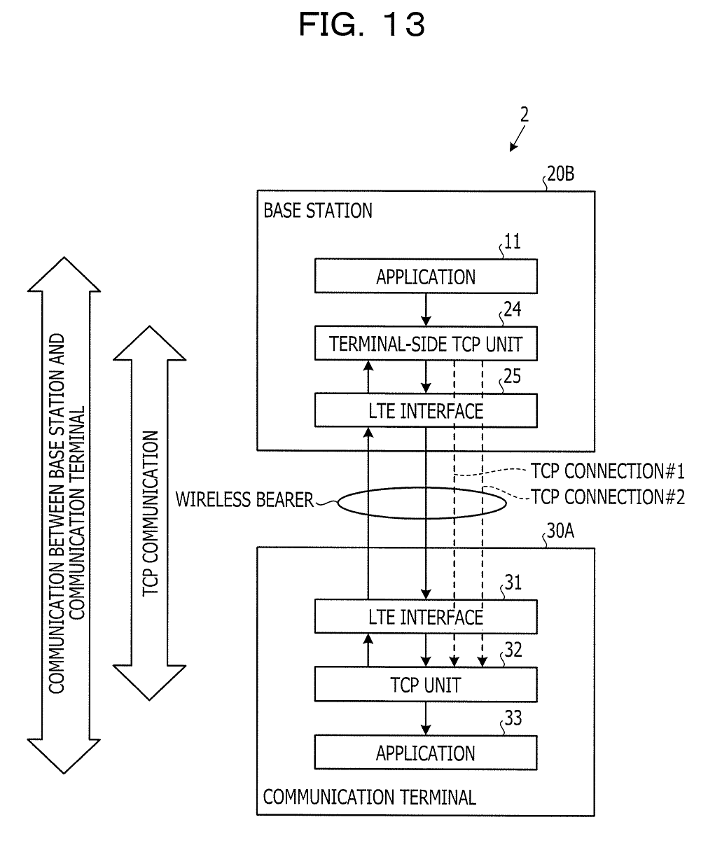

FIG. 13 is a view illustrating an example of configuration of a communication system in Embodiment 3. In FIG. 13, a communication system 2 includes a base station 20B. The base station 20B has the application 11. On the contrary, in Embodiment 1 (FIG. 2), the server 10 has the application 11. That is, in Embodiment 3, the application 11 installed in the server 10 in Embodiment 1 is shifted from the server 10 to the base station 20B, and is installed in the base station 20B. Accordingly, in Embodiment 3, the base station 20B includes neither server-side TCP unit 22 nor TCP proxy unit 23, and TCP connection is established between the base station 20B and the communication terminal 30A.

An application programming interface (API) between the TCP proxy unit 23 and the terminal-side TCP unit 24 in the base station 20A (FIG. 2) and an API between the application 11 and the terminal-side TCP unit 24 in the base station 20B are the same socket interface. Thus, the TCP proxy unit 23 and the application 11 are referred to as similar software modules by the terminal-side TCP unit 24.

Therefore, the terminal-side TCP unit 24 and the LTE interface 25 in Embodiment 3 execute the processing in the same manner as those in Embodiment 1 or Embodiment 2, achieving the same effects as those in Embodiment 1 or Embodiment 2.

### Embodiment 4

### <Exemplary Configuration of Communication System>

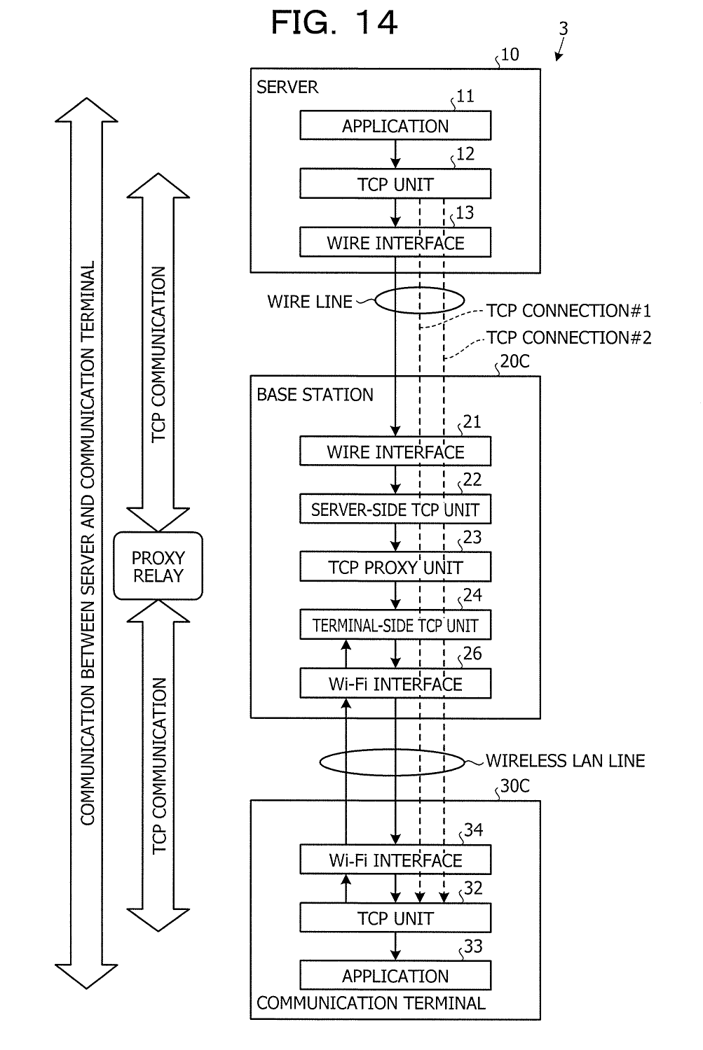

FIG. 14 is a view illustrating an example of configuration of a communication system in Embodiment 4. In FIG. 14, a communication system 3 includes a base station 20C and a communication terminal 30C. In Embodiment 1 (FIG. 2), the base station 20A is connected to the communication terminal 30A via the wireless bearer specified in LTE communication standard. That is, in Embodiment 1, the wireless channel between the base station 20A and the communication terminal 30A is wireless bearer. On the contrary, in Embodiment 4, as illustrated in FIG. 14, the base station 20C is connected to the communication terminal 30C via a wireless LAN line specified in the Wi-Fi communication standard or the wireless LAN (Local Area Network) communication standard. The wireless LAN line is an example of the wireless logical line. Accordingly, the base station 20C includes a Wi-Fi interface 26, and the communication terminal 30C includes a Wi-Fi interface 34. The Wi-Fi interface 26 executes wireless channel processing according to a Wi-Fi communication mode, and transmits the TCP packet received from the terminal-side TCP unit 24 to the communication terminal 30C. The Wi-Fi interface 34 executes wireless channel processing according to the Wi-Fi communication mode, receives the TCP packet transmitted from the base station 20C, and outputs the received TCP packet to the TCP unit 32.

The Wi-Fi interface 26 of the base station 20C has the same configuration as the LTE interface 25A (FIG. 3) in Embodiment 1 or the LTE interface 25B (FIG. 8) in Embodiment 2. According to the Wi-Fi communication standard and the wireless LAN communication standard, the wireless logical line serves as a single wireless LAN line, a wireless LAN line for each communication terminal, a wireless LAN line for each communication of various desired qualities, or a wireless LAN line for their combination, depending on the implementation. However, as in Embodiment 1 and Embodiment 2, a plurality of TCP connections established between the server 10 and the communication terminal 30C are collected on one wireless logical line. Thus, the terminal-side TCP unit 24 of the base station 20C converts the BP signal per wireless LAN line into the BP signal per TCP connection.

Thus, the terminal-side TCP unit 24 and the Wi-Fi interface 26 in Embodiment 4 execute the same processing as those in Embodiment 1 or Embodiment 2, achieving the same effects as those in Embodiment 1 or Embodiment 2.

### Embodiment 5

### <Exemplary Configuration of Communication System>

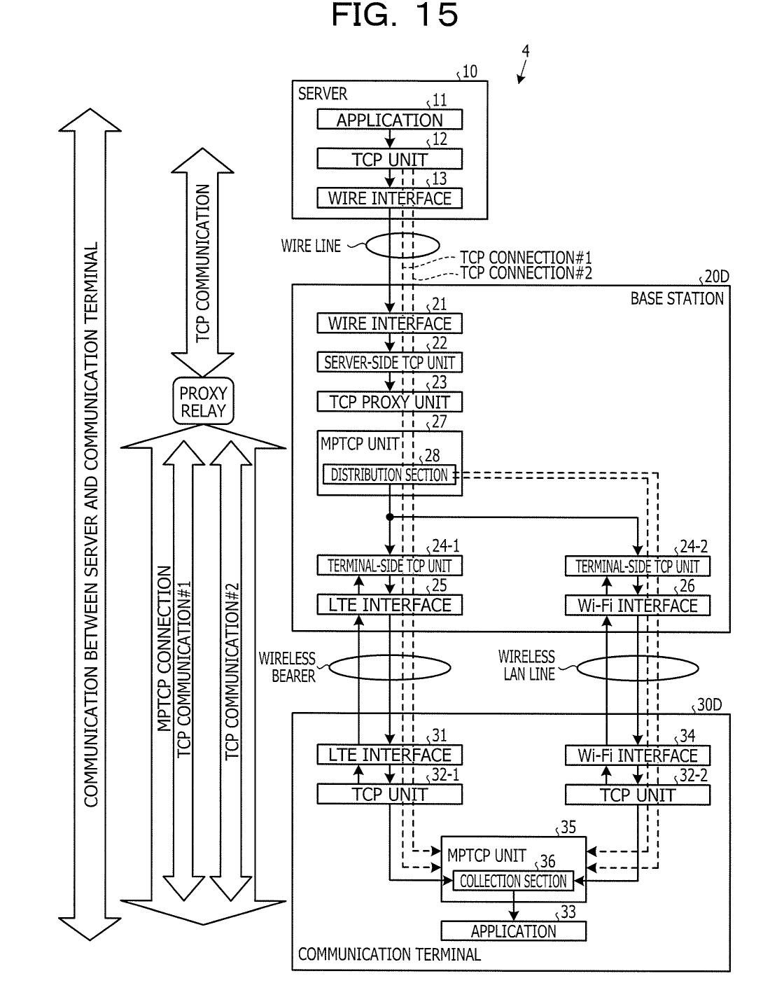

FIG. 15 is a view illustrating an example of configuration of a communication system in Embodiment 5. In FIG. 15, a communication system 4 includes a base station 20D and a communication terminal 30D. The base station 20D includes a Multipath TCP (MPTCP) unit 27 and terminal-side TCP units 24-1, 24-2. The MPTCP unit 27 has a distribution section 28. The terminal-side TCP unit 24-1 corresponds to the terminal-side TCP unit 24 in Embodiment 1 (FIG. 2), and the terminal-side TCP unit 24-2 corresponds to the terminal-side TCP unit 24 in Embodiment 4 (FIG. 14). The communication terminal 30D includes TCP units 32-1, 32-2 and an MPTCP unit 35. The MPTCP unit 35 has a collection section 36. The TCP unit 32-1 corresponds to the TCP unit 32 in Embodiment 1 (FIG. 2), and the TCP unit 32-2 corresponds to the TCP unit 32 in Embodiment 4 (FIG. 14).

The base station 20D uses both the LTE and Wi-Fi wireless channels for TCP communication between the server 10 and the communication terminal 30D, thereby increasing throughput of TCP communication between the server 10 and the communication terminal 30D.

The TCP proxy unit 23 of the base station 20D terminates TCP communication between the server 10 and the communication terminal 30D at the base station 20D once and then, establishes MPTCP connection between the base station 20D and the communication terminal 30D. Thereby, the TCP proxy unit 23 relays TCP communication between the server 10 and the base station 20D to MPTCP communication between the base station 20D and the communication terminal 30D.

The MPTCP is an extension of TCP, which enables a plurality of paths (in FIG. 15, via LTE interface and Wi-Fi interface) to be available simultaneously. The MPTCP is standardized by the standardizing institution, Internet Engineering Task Force (IETF). The MPTCP includes a plurality of TCP connections (a plurality of sub-flows) and MPTCP connection collecting the plurality of TCP connections. In a certain MPTCP connection, the distribution section 28 of the base station 20D distributes each TCP packet between TCP connection via the LTE interface and TCP connection via the Wi-Fi interface. At this time, the distribution section 28 adds a sequence number of the MPTCP connection level to the TCP packet in addition to the sequence number of the TCP connection level. Meanwhile, the collection section 36 of the communication terminal 30D sorts the received TCP packets via their respective TCP connections, based on the sequence number of the MPTCP connection level, and outputs app-data to the application 33. The distribution section 28, for example, distributes the TCP packet to the TCP connection having the smallest smoothed round trip time (srtt) among a plurality of TCP connections collected at MPTCP connection. As another example, the distribution section 28 distributes the TCP packet to the TCP connection having the smallest ratio of in-flight packets to an estimated bandwidth calculated based on the congestion window value (that is, a bandwidth usage ratio) among a plurality of TCP connections collected at MPTCP connection.

The terminal-side TCP unit 24-1 corresponding to the terminal-side TCP unit 24 (FIG. 2) and the LTE interface 25 execute the same processing as those in Embodiment 1 or Embodiment 2. The terminal-side TCP unit 24-2 corresponding to the terminal-side TCP unit 24 (FIG. 14) and the Wi-Fi interface 26 execute the same processing as those in Embodiment 4. Thus, Embodiment 5 achieves the same effects as the effects in Embodiment 1, Embodiment 2 or Embodiment 4.

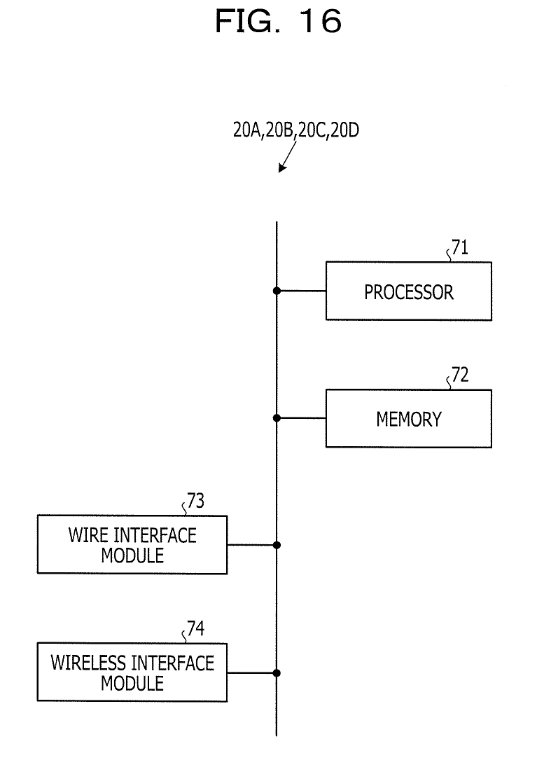

### Other embodiments

[1] The base stations 20A, 20B, 20C, and 20D may be realized with following hardware configuration. FIG. 16 is a view illustrating exemplary hardware configuration of the base station. As illustrated in FIG. 16, the base station 20A, 20B, 20C, and 20D each include, as hardware constituents, a processor 71, a memory 72, a wire interface module 73, and wireless interface module 74. Examples of the processor 71 includes a central processing unit (CPU), a digital signal processor (DSP), and a field programmable gate array (FPGA). The base stations 20A, 20B, 20C, and 20D may each include the processor 71 and a large scale integrated circuit (LSI) including a peripheral circuit. Examples of the memory 72 include RAM, such as SDRAM, ROM, and flash memory.

The wire interface 21 is implemented as the wire interface module 73. The wireless processing sections 253, 258 are implemented as the wireless interface module 74. The TCP packet creation section 241, the BP conversion section 242, the congestion window value setting section 243, the ACK information acquisition sections 244, 247, the congestion control section 245, and the retransmission control section 246 are implemented as the processor 71. The buffer monitoring section 252, the packet loss detection section 255, the ACK packet generation section 257, and the distribution section 28 are implemented as the processor 71. The transmission buffer 251 and the ACK information storage section 256 are implemented as the memory 72.

[2] The processing in the above description of the base stations 20A, 20B, 20C, 20D may be executed by causing the processor 71 to execute a program having a function corresponding to each processing. For example, the program having a function corresponding to each processing in the above description may be stored in the memory 72, and the processor 71 may read the program from the memory 72 and execute the read program. Each program does not have to be stored in the memory 72 in advance. That is, for example, each program may be previously stored in a mobile recording medium such as magnetic disc, optical disc, IC card, or memory card, which may be connected to the base stations 20A, 20B, 20C, and 20D, and the processor 71 may read each program from the recording medium. Alternatively, each program may be stored in a computer or a server connected to the base station 20A, 20B, 20C, and 20D via the Internet, LAN, wireless LAN, or so on in a wired or wireless manner, and the processor 71 may read and execute the program.

[3] Embodiment 1 may be combined with Embodiment 2. That is, the base stations 20A, 20B, 20C, and 20D may perform the congestion control described in Embodiment 1 and the retransmission control described in Embodiment 2 in parallel.

[4] In Embodiment 1, the congestion window value setting section 243 decreases the congestion window value to the predetermined value, when the TCP packet retention volume in the transmission buffer 251 becomes equal to or larger than the threshold value. The congestion window value setting section 243 increases the congestion window value to a value equal to or larger than the receive window value, when the TCP packet retention volume in the transmission buffer 251 becomes less than the threshold value. Here, as the TCP packet retention volume in the transmission buffer 251 is larger, the free space in the transmission buffer 251 is smaller. Conversely, as the TCP packet retention volume in the transmission buffer 251 is smaller, the free space in the transmission buffer 251 is larger. That is, the TCP packet retention volume in the transmission buffer 251 and the free space in the transmission buffer 251 have one-to-one correspondence. Thus, the congestion window value setting section 243 may decrease the congestion window value to a predetermined value, when the free space in the transmission buffer 251 becomes less than a threshold value. The congestion window value setting section 243 may increase the congestion window value to a value equal to or larger than the receive window value, when the free space in the transmission buffer 251 becomes equal to or larger than the threshold value.

[5] For example, the above-mentioned BP signal (back pressure signal) corresponds to buffer control signal recited in claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station comprising:
a memory configured to store a transmission buffer storing each packet to be transmitted to a terminal via a wireless channel; and
a processor configured to:
control volume of packets flowing in the transmission buffer based on a smaller value of a congestion window value and a receive window value, the congestion window value indicating a number of packets that the base station is allowed to transmit until receiving each acknowledgement of each packet transmitted to the terminal, the receive window value being reported from the terminal, and
set the congestion window value to a first value when volume of packets stored in the transmission buffer is equal to or larger than a threshold value and to a second value that is not less than the received window value larger than the first value when volume of packets stored in the transmission buffer is smaller than the threshold value.

2. The base station according to claim 1, wherein the first value is zero.

3. The base station according to claim 1, wherein
the processor is further configured to:
generate a first buffer control signal when volume of packets stored in the transmission buffer is equal to or larger than the threshold value, and
generate each second buffer control signal based on the first buffer control signal, each second buffer control signal being generated for each connection between the base station and the terminal, and
each congestion window value for each connection is set to the first value based on each second buffer control signal.

4. The base station according to claim 1, wherein the wireless channel is a radio bearer provided in Long Term Evolution (LTE) standard.

5. The base station according to claim 1, wherein the wireless channel is a wireless local area network (LAN) channel provided in Wi-Fi standard.

6. The base station according to claim 1, wherein each packet stored in the transmission buffer is a transmission control protocol (TCP) packet.

7. A base station comprising:
a memory; and
a processor coupled to the memory and configured to:
generate a specified acknowledgment (ACK) packet indicating a specified ACK number and each specified selective ACK (SACK) number when a packet is lost in a wireless channel between the base station and a terminal, the specified ACK number being a ACK number that has been received from the terminal, each specified SACK number being each SACK number between the specified ACK number and a SACK number of a next packet of the lost packet without a SACK number of the lost packet, and
perform retransmission control of the lost packet based on the specified ACK packet.

8. The base station according to claim 7, wherein
the memory is configured to store a transmission buffer storing each packet to be transmitted to the terminal via the wireless channel, and
the specified ACK packet is generated when the next packet of the lost packet is stored in the transmission buffer.

9. The base station according to claim 7, wherein the wireless channel is a radio bearer provided in Long Term Evolution (LTE) standard.

10. The base station according to claim 7, wherein the wireless channel is a wireless local area network (LAN) channel provided in Wi-Fi standard.

11. The base station according to claim 7, wherein the retransmission control is performed based on a transmission control protocol (TCP).

12. A communication control method comprising:
controlling volume of packets flowing in a transmission buffer stored in a memory of the base station based on a smaller value of a congestion window value and a receive window value, the transmission buffer storing each packet to be transmitted to a terminal via a wireless channel, the congestion window value indicating a number of packets that the base station is allowed to transmit until receiving each acknowledgement of each packet transmitted to the terminal, the receive window value being reported from the terminal; and
setting the congestion window value to a first value when volume of packets stored in the transmission buffer is equal to or larger than a threshold value and to a second value that is not less than the received window value larger than the first value when volume of packets stored in the transmission buffer is smaller than the threshold value.
